(19) United States
(12) Patent Application Publication
(10) Pub. No.: US 2026/0148235 A1
(43) Pub. Date: May 28, 2026

(54) COMPUTER PLATFORMS DESIGNED FOR AUTOMATED COMPUTER-BASED FRAUD DETECTION AND METHODS OF USE THEREOF

(71) Applicants: Marie B. LaQuerre, Matthews, NC (US); Donna D. Turner, Huntersville, NC (US)

(72) Inventors: Marie B. LaQuerre, Matthews, NC (US); Donna D. Turner, Huntersville, NC (US)

(21) Appl. No.: 19/397,442

(22) Filed: Nov. 21, 2025

Related U.S. Application Data
(60) Provisional application No. 63/724,098, filed on Nov. 22, 2024.

(51) Int. Cl. G06Q 20/40

(52) U.S. Cl. CPC G06Q 20/4016

(57) ABSTRACT

In order to detect fraudulent activities in document processing, particularly business checks, systems and methods include integrating front and back image analysis of checks such that endorsement imagery, including handwritten signatures, printed or stamped endorsements, and alphanumeric data, is extracted and analyzed; employing advanced technologies such as optical character recognition and machine learning to derive endorsement features; comparing the extracted features against reference data, including issuance-file records and historical endorsement imagery stored in a multi-institution repository; performing temporal pattern analysis and cross-channel correlation with additional transaction data to enhance anomaly detection; triggering automated responses, such as placing funds holds, rerouting items for review, or initiating breach-of-warranty claims, in response to detected discrepancies; ensuring secure data exchange via encrypted application programming interfaces; and generating tamper-evident audit logs for traceability, whereby fraud detection accuracy is improved, false positives are reduced, and operational efficiency in financial transactions is enhanced.

### FIELD OF TECHNOLOGY

This application claims priority to and the benefit of U.S. Provisional Application No. 63/724,098, filed Nov. 22, 2024, the contents of which are incorporated herein by references in its entirety.

### FIELD OF TECHNOLOGY

In some embodiments, the present disclosure is related to computer-implemented methods and computer systems for detecting fraudulent activities, including electronic communication network and computer vision techniques for fraud detection and automated mitigation.

### BACKGROUND OF TECHNOLOGY

Payment instruments are processed electronically by financial institutions deploying services such as Positive Pay, Payee Positive Pay, and remote deposit capture to screen front-of-check fields including check number, amount, and payee name. In such deployments, however, these approaches often generate false positives, are not universally adopted by businesses, and do not extend verification to endorsement imagery on the back of a check or enable cross-institutional data sharing. Fraudsters take advantage of these gaps by altering endorsements, stamps, or payee address fields and routing items through multiple institutions, exposing businesses and banks to breach-of-warranty liability and costly losses. As a result, there remains a need for more robust and efficient fraud detection techniques that integrate multiple data sources and provide actionable insights without significantly disrupting existing workflows.

### SUMMARY

In some aspects, the techniques described herein relate to a computer-implemented method for detecting fraudulent or altered document items, including: extracting, by at least one processor, using at least one image analysis model, back image feature data including at least one back image feature associated with the at least one back image data item represented in a back image of a document item; wherein the at least one back image data item represents at least one item, on a back of the document item, including: a handwritten signature, at least one printed endorsement, at least one stamped endorsement, at least one alphanumeric endorsement data, or at least one bank processing data item; detecting, by the at least one processor, using at least one endorsement-feature pattern analysis, at least one discrepancy of the back image feature data from reference data; wherein the reference data includes historical endorsement imagery stored in a verification repository, the verification repository including endorsement imagery, transaction history, and risk data contributed and updated in near real-time by a plurality of participating entities; wherein the at least one endorsement-feature pattern analysis includes at least one of: temporal pattern analysis on the endorsement-feature data across a plurality of previously presented document items to identify behavioral anomalies, or correlation analysis between the endorsement-feature data and transaction data from at least one additional data channel; and automatically routing, by the at least one processor, based at least in part on the discrepancy, the document item to at least one operational action to mitigate fraud associated with the discrepancy.

In some aspects, the techniques described herein relate to a computer-implemented method, wherein extracting endorsement imagery from the back image of the presented document item further includes segmenting an endorsement region using image processing algorithms to isolate handwritten signatures, printed or stamped endorsements, and alphanumeric endorsement data.

In some aspects, the techniques described herein relate to a computer-implemented method, wherein analyzing the extracted endorsement imagery using optical character recognition and machine-learning pattern recognition further includes generating feature vectors representing signature geometry, stamp placement, and text content for subsequent comparison.

In some aspects, the techniques described herein relate to a computer-implemented method, wherein comparing the endorsement-feature data to reference data further includes executing a similarity scoring algorithm to quantify a degree of match between the extracted endorsement-feature data and historical endorsement imagery stored in the verification repository.

In some aspects, the techniques described herein relate to a computer-implemented method, wherein performing temporal pattern analysis on the endorsement-feature data includes applying time-series anomaly detection models to identify outlier behaviors in endorsement presentation frequency and sequence.

In some aspects, the techniques described herein relate to a computer-implemented method, wherein performing cross-channel correlation between the endorsement-feature data and transaction data from at least one additional data channel includes integrating data from automated clearing house transactions, wire transfers, and payment card activity using a multi-modal data fusion engine.

In some aspects, the techniques described herein relate to a computer-implemented method, wherein determining that a discrepancy exists further includes applying a threshold-based decision logic to a similarity scoring algorithm, temporal pattern analysis, and cross-channel correlation.

In some aspects, the techniques described herein relate to a computer-implemented method, wherein automatically generating a response instruction includes invoking a rule-based operational response engine configured to select and execute one or more operational actions based on a type and severity of the detected discrepancy.

In some aspects, the techniques described herein relate to a computer-implemented method, further including generating a tamper-evident audit log by cryptographically hashing each step of an endorsement validation and response instruction process and storing the hashes in an immutable ledger.

In some aspects, the techniques described herein relate to a computer-implemented method, wherein the verification repository is accessed via secure application programming interfaces, and is associated with at least one of: a payee entity associated with receiving the document item, or a payer entity associated with issuing the document item.

In some aspects, the techniques described herein relate to a fraud-detection system for identifying potentially fraudulent business checks, including: one or more processors; and a memory storing instructions executable by the processors to: extract, using at least one image analysis model, back image feature data including at least one back image feature associated with the at least one back image data item represented in a back image of a document item; wherein the at least one back image data item represents at least one item, on a back of the document item, including: a handwritten signature, at least one printed endorsement, at least one stamped endorsement, at least one alphanumeric endorsement data, or at least one bank processing data item; detect, using at least one endorsement-feature pattern analysis, at least one discrepancy of the back image feature data from reference data; wherein the reference data includes historical endorsement imagery stored in a verification repository, the verification repository including endorsement imagery, transaction history, and risk data contributed and updated in near real-time by a plurality of participating entities; wherein the at least one endorsement-feature pattern analysis includes at least one of: temporal pattern analysis on the endorsement-feature data across a plurality of previously presented document items to identify behavioral anomalies, or correlation analysis between the endorsement-feature data and transaction data from at least one additional data channel; and automatically rout, based at least in part on the discrepancy, the document item to at least one operational action to mitigate fraud associated with the discrepancy.

In some aspects, the techniques described herein relate to a system, wherein extracting endorsement imagery from the back image of the presented document item further includes segmenting an endorsement region using image processing algorithms to isolate handwritten signatures, printed or stamped endorsements, and alphanumeric endorsement data.

In some aspects, the techniques described herein relate to a system, wherein analyzing the extracted endorsement imagery using optical character recognition and machine-learning pattern recognition further includes generating feature vectors representing signature geometry, stamp placement, and text content for subsequent comparison.

In some aspects, the techniques described herein relate to a system, wherein comparing the endorsement-feature data to reference data further includes executing a similarity scoring algorithm to quantify a degree of match between the extracted endorsement-feature data and historical endorsement imagery stored in the verification repository.

In some aspects, the techniques described herein relate to a system, wherein performing temporal pattern analysis on the endorsement-feature data includes applying time-series anomaly detection models to identify outlier behaviors in endorsement presentation frequency and sequence.

In some aspects, the techniques described herein relate to a system, wherein performing cross-channel correlation between the endorsement-feature data and transaction data from at least one additional data channel includes integrating data from automated clearing house transactions, wire transfers, and payment card activity using a multi-modal data fusion engine.

In some aspects, the techniques described herein relate to a system, wherein determining that a discrepancy exists further includes applying a threshold-based decision logic to a similarity scoring algorithm, temporal pattern analysis, and cross-channel correlation.

In some aspects, the techniques described herein relate to a system, wherein automatically generating a response instruction includes invoking a rule-based operational response engine configured to select and execute one or more operational actions based on a type and severity of the detected discrepancy.

In some aspects, the techniques described herein relate to a system, further including generating a tamper-evident audit log by cryptographically hashing each step of an endorsement validation and response instruction process and storing the hashes in an immutable ledger.

In some aspects, the techniques described herein relate to a system, wherein the verification repository is accessed via secure application programming interfaces, and is associated with at least one of: a payee entity associated with receiving the document item, or a payer entity associated with issuing the document item.

### BRIEF DESCRIPTION OF THE DRAWINGS

Various embodiments of the present disclosure can be further understood with reference to FIGS. 1-13, wherein like elements are designated by like reference numerals throughout the several views. The drawings are not necessarily to scale, with emphasis instead being placed upon illustrating the principles of the present disclosure. The specific structural and functional details disclosed herein are not to be interpreted as limiting, but merely as representative examples for teaching one skilled in the art to variously employ one or more illustrative embodiments.

FIG. 1 illustrates a system diagram providing an overview of a fraud detection system configured to analyze front and back check images and generate operational responses to suspected fraud in accordance with one or more embodiments of the present disclosure.

FIG. 2 illustrates a flowchart of a fraud detection process for analyzing check images, identifying discrepancies, and triggering appropriate responses in accordance with one or more embodiments of the present disclosure.

FIGS. 3A and 3B illustrate schematics of a check highlighting data fields, including the payee line, date field, amount field, drawer signature, check number, and MICR line in accordance with one or more embodiments of the present disclosure.

FIG. 4 illustrates the back of a check, emphasizing the endorsement region, which includes a handwritten endorsement and/or a business endorsement stamp in accordance with one or more embodiments of the present disclosure.

FIG. 5 illustrates a block diagram of the fraud detection module, including components for temporal analysis, cross-channel correlation, heuristic validation, and audit logging, and culminating in transaction approval or fraud response in accordance with one or more embodiments of the present disclosure.

FIG. 6 illustrates an exemplary network diagram of a consortium-based interbank communication system that enables secure API interfaces for data exchange among financial institutions in accordance with one or more embodiments of the present disclosure.

FIG. 7 illustrates a flowchart of the fraud detection decision process, detailing operational responses such as holding funds, exception review and clearing routing, and breach-of-warranty claim initiation in accordance with one or more embodiments of the present disclosure.

FIG. 8 illustrates a system diagram of a remote deposit scanner setup for capturing front and back images of a check and transmitting the data to a workstation for processing in accordance with one or more embodiments of the present disclosure.

FIG. 9 illustrates a flowchart of the audit log and notification framework for generating tamper-evident records and transmitting interbank notifications to a receiving financial institution in accordance with one or more embodiments of the present disclosure.

FIG. 10 illustrates a network diagram showcasing client-server interactions with cloud services, including cloud infrastructure, platform, and storage components in accordance with one or more embodiments of the present disclosure.

FIG. 11 illustrates a block diagram of a cloud service model architecture, detailing the layers of IaaS, PaaS, and SaaS along with their interaction with client applications in accordance with one or more embodiments of the present disclosure.

FIG. 12 illustrates a system diagram of an exemplary fraud detection system in accordance with one or more embodiments of the present disclosure.

### DETAILED DESCRIPTION

In some embodiments, existing fraud detection implementations may omit endorsement imagery and endorsement-stamp content as first-class inputs, thereby limiting observable evidence available to analytics. In some embodiments, adversaries can alter fields that issuance files do not validate, including, without limitation, payee addresses, endorsement stamps, and handwritten signatures, which can evade front-of-document comparisons. In some embodiments, mobile capture approaches may be consumer-centric and may not be tailored to enterprise or business check environments, leading to variability in image quality, workflow fit, and governance controls. In some embodiments, cross-institutional fraud detection and data sharing can be underdeveloped, permitting gaps when fraudulent presentments traverse multiple institutions without corroboration. In some embodiments, conventional systems may conclude with a fraud score or pass/fail indication without coupling outcomes to operational banking processes, and may not automatically trigger actions such as funds holds, exception processing, review and clearing, or breach-of-warranty claims, which could otherwise reduce loss exposure and improve timeliness of containment.

In some embodiments, a systemic solution can extend fraud detection beyond front-of-check validation to incorporate additional front-of-document elements prevalent in business items, to include endorsement-region content, and to leverage endorsement stamps and handwritten signatures as verification features. In some embodiments, such a solution may further integrate observed transactional history and may interoperate with multi-institution repositories to provide cross-entity corroboration and to inhibit exploitation of institution-specific gaps. In some embodiments, the solution can generate actionable outputs that are operably coupled to operational banking processes, including, without limitation, funds-hold placement, exception routing, and claim initiation, thereby reducing liability exposure and improving detection accuracy. In some embodiments, the described improvements may advantageously benefit paying institutions, depository institutions, and issuing businesses by enhancing verification completeness, accelerating containment, and improving disposition quality across the financial ecosystem.

Various detailed embodiments of the present disclosure, taken in conjunction with the accompanying FIGs., are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

The present disclosure relates generally to systems and methods for detecting fraudulent activities, such as in the context of bank check processing. More specifically, the disclosed system provides a comprehensive solution for identifying and mitigating fraud in digital and/or physical documents by analyzing both front and back images of the virtual/physical documents, including endorsement imagery, and leveraging multi-institution repositories for cross-referencing and validation. The disclosed technology addresses longstanding challenges in the financial industry by integrating advanced fraud detection techniques, such as optical character recognition (OCR), machine learning, and heuristic validation, in tandem with multi-institution repositories that provide datasets for assessing fraudulent data to enhance the accuracy and efficiency of fraud prevention measures.

The embodiments described herein are provided for illustrative purposes and are not intended to limit the scope of the described subject matter. Certain details, well-known to those skilled in the art, may be omitted for clarity and brevity. It is to be understood that various modifications, rearrangements, and substitutions of components or steps may be made without departing from the spirit and scope of the described subject matter. The disclosed systems and methods are adaptable to a wide range of applications and configurations, ensuring flexibility and scalability to meet diverse operational needs.

The problem of check fraud has persisted as a significant challenge, particularly in the business sector, where financial institutions (FIs) often lack sufficient liability and incentive to invest in robust fraud detection technologies. Existing solutions primarily focus on front-of-check validation, including check numbers, amounts, and payee names. However, these systems are not universally adopted, frequently generate false positives, and fail to address vulnerabilities such as alterations to endorsement imagery, payee addresses, or handwritten signatures on the back of checks. Furthermore, these solutions do not extend to cross-institutional fraud detection or operational responses, leaving gaps that fraudsters exploit by routing altered or counterfeit checks through multiple financial institutions. The lack of integration between front-of-check and back-of-check validation, combined with limited interbank collaboration, exposes businesses and banks to breach-of-warranty liabilities and substantial financial losses.

The present system and method address these limitations by introducing a comprehensive approach for detecting fraudulent business checks through the analysis of both front and back check images, with validation of check characteristics such as, e.g., endorsement imagery, payee address, among other characteristics or any combination thereof. Unlike conventional approaches, the described system incorporates advanced technologies such as optical character recognition (OCR), machine learning (ML), and heuristic validation to extract and analyze endorsement signatures, stamps, the payee address, business information associated with the payee (e.g., titling (payee) alterations among others), and other back-of-check elements. These features are cross-referenced against trusted reference data, including issuance files, historical transaction records, and multi-institution repositories. The system utilizes temporal pattern analysis to detect anomalies in check issuance and presentment sequences, as well as cross-channel correlation to identify irregularities across payment modalities such as ACH, wire transfers, and card transactions. By integrating these capabilities, the described system provides a robust fraud detection mechanism that not only identifies discrepancies but also triggers actionable responses, such as placing funds holds, rerouting checks into one or more exception processes (e.g., exception review and clearing), or initiating breach-of-warranty claims.

The described solution further enhances fraud detection accuracy and operational efficiency by enabling interbank electronic data services that enable collaboration through secure API interfaces and consortium-based data repositories. This computer and network architecture allows financial institutions to share endorsement imagery and risk data in near real-time, preventing fraudsters from exploiting gaps between institutions. Additionally, the system generates tamper-evident audit logs to ensure transparency and traceability, supporting robust model governance and compliance. By expanding fraud detection to include endorsement imagery and integrating this capability with advanced analytics and interbank communication, the described approach provides a transformative method for mitigating check fraud in the business sector, offering significant technical and practical benefits over existing solutions.

In some embodiments, receipt of front and back images of a presented document item enables image-based evaluation of both obverse and reverse sides of the document item. Inclusion of reverse-side imagery introduces endorsement-region content into the analytic pipeline, thereby increasing detection coverage for fraud indicators that are not present on the front side alone. Integration of both sides within a single processing workflow reduces omission of endorsement-derived risk signals and improves verification completeness relative to front-only screening architectures.

In some embodiments, segmentation and extraction of endorsement imagery from the back image, including handwritten signature content, printed or stamped endorsements, and alphanumeric endorsement data, isolates a region of heightened evidentiary value for downstream processing. Region-of-interest isolation improves signal-to-noise characteristics for optical and geometric features within the endorsement zone, resulting in higher fidelity feature vectors for subsequent comparison. Confinement of analysis to an endorsement subregion reduces interference from extraneous background artifacts and improves consistency of feature generation across heterogeneous check layouts.

In some embodiments, application of optical character recognition and machine-learning pattern recognition to the extracted endorsement imagery produces structured endorsement-feature data encompassing, without limitation, signature geometry, stroke flow, stamp placement, spatial layout, text strings, and font or glyph-level attributes. Transformation of unstructured imagery into machine-interpretable features enables deterministic and probabilistic matching against reference records. Learning-based pattern discriminators increase sensitivity to subtle manipulations, such as micro-adjustments in stamp offsets, kerning irregularities, or atypical curvature in signature strokes, thereby elevating detection of sophisticated alterations beyond the capabilities of rule-only systems.

Thus, in some embodiments, the front and back images may have check feature data that can be extracted via the optical character recognition and image processing, including ML processing of the images. In some embodiments, comparison of check-feature data to reference data sources, including issuance-file records from an issuing entity and historical endorsement imagery stored in a repository (e.g., an intra-bank repository, a multi-institution repository, a federated repository, a consortium repository, a peer-to-peer communication, etc.), establishes a cross-entity validation layer. Access to consortium-scale imagery and risk contributions expands the baseline population for similarity scoring and anomaly detection, improving separation between legitimate and fraudulent presentments. Secure application-programming-interface access with encryption and authentication preserves integrity and confidentiality of interbank queries and responses, enabling reliable incorporation of external corroboration signals into the decision process.

In some embodiments, execution of temporal pattern analysis across previously presented document items enables identification of behavioral anomalies in issuance-to-presentment chronology, endorsement-sequence ordering, frequency patterns, and spatial-layout drift over time. Time-series modeling of endorsement-derived features detects out-of-family events, including abrupt changes in stamp geometry or endorsement lexicon, that may not breach static similarity thresholds but indicate progressive compromise or template substitution. Temporal analysis further reduces false positives by recognizing legitimate seasonal or operational periodicities for particular payees or counterparties.

In some embodiments, cross-channel correlation between endorsement-feature data and transaction streams from additional data channels, such as automated clearing house transactions, wire transfers, and payment card activity, implements multi-modal risk fusion. Alignment of endorsement anomalies with contemporaneous channel-specific risk factors generates compound indicators with increased positive predictive value. Multi-source corroboration reduces reliance on any single modality and mitigates error propagation from one data source, thereby improving robustness of the overall fraud signal.

In some embodiments, discrepancy determination using thresholded similarity scores, temporal anomaly indices, and cross-channel correlation outputs provides a composite, configurable decision mechanism. Weighted aggregation of heterogeneous indicators yields calibrated risk outcomes suitable for both automated and human-in-the-loop operations. Configurable thresholds facilitate adaptation to institution-specific risk tolerances and evolving threat patterns without architectural modification.

In some embodiments, automatic generation of a response instruction upon discrepancy determination provides operational enforcement within existing banking workflows. Response instruction options include placement of a funds or data hold, routing of an item into a non-standard processing channel for expedited review and potential return, and initiation of a claim or interbank notification. Automation of these actions reduces latency between detection and containment, limits loss exposure, and preserves regulatory return windows. Coupling of analytic outcomes to enforceable operational steps ensures that elevated risk conditions produce tangible protective measures rather than passive alerts.

In some embodiments, generation of tamper-evident audit logs by cryptographically hashing analytic steps, intermediate features, and response decisions creates immutable lineage for model-governance, regulatory, and evidentiary needs. Immutable logging supports traceability of each decision back to underlying inputs and processing modules, enabling post-incident analysis, continuous improvement of models and heuristics, and defensibility in interbank disputes.

In some embodiments, integration of endorsement-region analysis, OCR-and ML-based feature extraction, cross-entity repository comparison, temporal-behavioral modeling, cross-channel risk fusion, calibrated discrepancy scoring, and automated operational responses yields a technical improvement to computer-centric fraud detection platforms. The combined architecture increases detection accuracy for altered, forged, or intercepted items, reduces false positives relative to front-only checks, shortens detection-to-action cycle time, and enhances resilience against cross-institutional evasion tactics by exploiting endorsement imagery and multi-institution data at scale.

In some embodiments, extraction of endorsement imagery from the reverse side of a business check, including handwritten signatures, printed or stamped endorsements, and alphanumeric endorsement data, enables comprehensive authenticity analysis beyond front-of-check validation. Inclusion of reverse-side imagery introduces endorsement-region content into the analytic pipeline, increasing detection coverage for fraud indicators not present on the obverse image and elevating the likelihood of identifying altered or counterfeit items.

In some embodiments, utilization of optical character recognition and machine-learning analysis transforms unstructured endorsement imagery into structured endorsement-feature data comprising, without limitation, signature geometry, stamp placement, spatial layout, and text strings. Conversion to structured data facilitates deterministic and probabilistic comparison against issuer-provided issuance-file records and historical endorsement imagery stored in consortium-scale repositories, thereby improving sensitivity to subtle discrepancies such as micro-variations in signature curvature or stamp offset.

In some embodiments, integration with a multi-institution repository provides access to endorsement imagery, transaction history, and risk data contributed in near real-time by participating financial institutions, expanding baseline populations for similarity scoring and anomaly detection. Cross-entity data availability improves separation between legitimate and fraudulent presentments and reduces exploitation of institution-specific gaps by enabling corroboration across repositories maintained by multiple entities.

In some embodiments, generation of a fraud-response output upon detection of a discrepancy couples analytic outcomes to enforceable operational steps. Fraud-response outputs include placement of a funds hold, rerouting of an item into one or more exception processes (e.g., exception review and clearing) for expedited review, and initiation of a breach-of-warranty alert to a receiving financial institution. Operational coupling reduces latency between detection and containment, minimizes loss exposure, and supports adherence to regulatory return windows.

In some embodiments, access to external repositories and services is performed via secure application-programming interfaces implementing end-to-end encryption and authentication, preserving integrity and confidentiality of interbank queries and responses. Secure communication frameworks improve reliability of cross-entity verification and validation, sustaining trust requirements for production deployment and compliance regimes within financial institutions.

In some embodiments, endorsement-region extraction, OCR-and ML-based feature structuring, consortium-scale cross-entity comparison, and automated operational response generation yield technical improvements in fraud detection accuracy, false-positive reduction, decision-to-action cycle time, and resilience against cross-institutional evasion tactics. These improvements arise from systematic incorporation of reverse-side endorsement content and secure multi-institution data into a unified analytic and operational workflow.

An exemplary embodiment includes a system, method, and computer-readable medium for detecting fraudulent checks by analyzing both the front and back images of presented items and comparing key elements and item characteristics to trusted reference data sources.

Unlike existing positive pay and payee positive pay services, which primarily verify front-of-check fields such as item number, amount, date and payee name, the exemplary embodiment includes back-of-check endorsement imagery, including handwritten endorsements and endorsement stamps, as well as the payee address information, into the fraud detection process.

The exemplary embodiment includes a fraud detection system receives images of a presented check, extracts endorsement imagery from the back of the check, in addition to elements from the front of the image (i.e. date and full payee name and address) and applies optical character recognition or machine learning analysis to identify relevant signature and stamp data. These additional elements and the endorsement information is compared against reference data, either internal or externally hosted that may include issuer-provided issuance files, positive pay records, stored signature specimens, transaction history, etc., and a verification repository of endorsement images maintained by multiple financial institutions.

The exemplary embodiment includes leveraging temporal pattern analysis, comparing endorsement imagery across multiple checks over time; identifying inconsistencies in naming conventions, payee address irregularities, stamp placement, signature style or endorsement sequence, which can be incorporated into the fraud alerting capabilities. This is further supported by the ability to incorporate said endorsement elements and transaction metadata and correlating any anomalies with data from other payment channels including ACH, wire and payment cards. The independent and compound effect of these signals create a robust and accurate fraud alerting capability.

The exemplary embodiment includes encompassing a heuristic fallback validation for validating imagery when reference data is unavailable; apply heuristic rules to assess signature presence, stamp density and endorsement region occupancy, and generating a fraud detection output based on said heuristic assessment.

The exemplary embodiment includes, when discrepancies are detected, the system generates a fraud detection output that may include instructions to place a funds hold, reroute the item into one or more exception processes (e.g., including exception review, processing and/or clearing) for expedited review and potential return, or initiate a breach-of-warranty claim against the presenting institution. The invention also provides audit logging and interbank notification capabilities.

The exemplary embodiment includes deployment that may occur at the business, bank of first deposit, or paying bank, which can be affected at a single institution or via a network approach, leveraging API calls and responses, which negate the need for a single repository by a third party or a shared infrastructure. This configuration also enables a consortium deployment enables interbank collaboration and cross-institutional data sharing, thereby increasing detection accuracy.

The exemplary embodiment includes generating a tamper-evident audit log of endorsement validation steps; and automatically notifying relevant financial institutions upon detection of discrepancies, including breach of warranty claim initiation. This audit log also serves as a transparency mechanism to understand the elements behind the recommended operational actions, enabling robust model governance.

By expanding fraud detection to include endorsement imagery, signature presence, stamp density and endorsement region occupancy and coupling it with other data sources and patterns, operational enforcement actions and interbank repositories, the invention provides a more comprehensive mechanism to identify and prevent business check fraud.

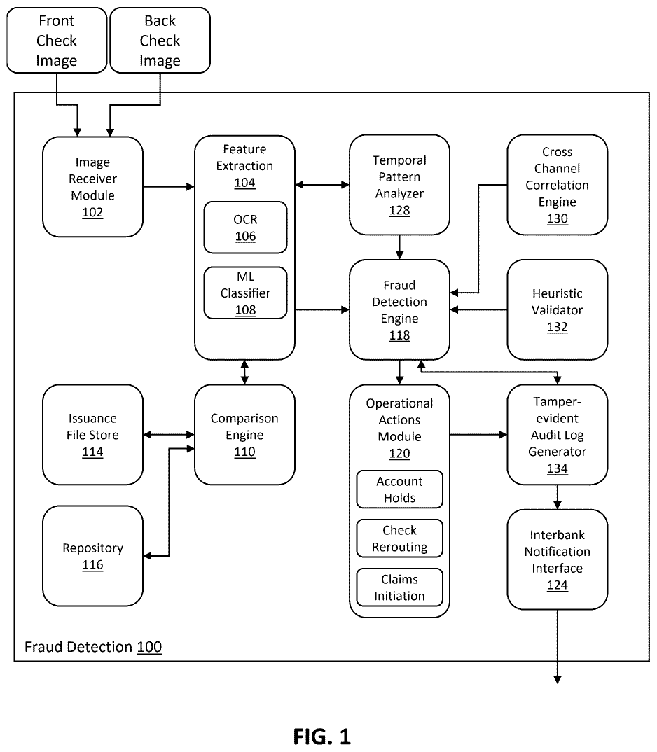

FIG. 1 illustrates a fraud detection system 100 configured to analyze document images and identify potentially fraudulent activities by leveraging advanced technologies and multi-institutional data repositories. In various embodiments, the fraud detection system 100 integrates multiple components to process, analyze, and respond to discrepancies in document transactions, where each component may be specifically configured to operate in concert to enhance detection accuracy and operational efficiency. Checks represent one example of document items processed by the system; other examples include remittance advices, money orders, payment vouchers, drafts, and identity or entitlement documents bearing endorsements or approvals.

In some embodiments, the fraud detection system 100 can include an image receiver module 102 that captures front and back images of a presented document item. In some embodiments, a presented document item is processed as a pair of coordinated images comprising an obverse (front) image and a reverse (back) image captured in accordance with imaging guidelines for resolution, contrast, and skew tolerance. The front image typically contains primary transaction or identity fields such as issuer identifiers, recipient or payee data, dates, monetary amounts or codes, and visible security features, which are parsed to establish baseline authenticity and linkage to reference records. The back image exposes an endorsement or approval region that may include handwritten signatures, printed or stamped endorsements, seals, barcodes, and auxiliary alphanumeric strings, providing secondary evidentiary content that is not available on the front. Joint ingestion of both images enables synchronized segmentation of field regions, optical character recognition across front and back text zones, and extraction of geometric and typographic features suitable for deterministic matching and probabilistic anomaly scoring. Integration of the two-sided imagery within a unified analytic pipeline increases signal coverage, reduces omission of endorsement-derived indicators, and improves confidence in document authenticity assessments relative to implementations limited to the front image alone.

The captured images are forwarded to a feature extraction module 104, which isolates an endorsement or approval region from the reverse side of the document. In certain embodiments, the feature extraction module 104 works in conjunction with an optical character recognition (OCR) module 106 and a machine learning (ML) classifier 108 to extract and interpret textual and graphical features from the front and back of the document, including from the endorsement region of the back of the check. These document features may include, without limitation, issuer identifiers, recipient or payee data, dates, monetary amounts or codes, and visible security features, handwritten signatures, printed or stamped endorsements, seals, barcodes, and alphanumeric data, among others or any combination thereof.

In some embodiments, the OCR module 106 is configured to convert pixels within a document image into structured textual elements with associated spatial coordinates and calibrated confidence values. The OCR module 106 accepts as input one or more cropped regions from the feature extraction module 104 and, optionally, front-of-document regions identified by the image receiver module 102, and returns a structured payload containing line, word, and token objects, each annotated with a bounding polygon, a confidence score, a reading-order index, and a field-type hypothesis.

In some embodiments, the OCR module 106 performs image-quality assessment and pre-processing prior to character inference. Quality assessment computes metrics including resolution, focus, contrast, noise level, illumination uniformity, and skew. Pre-processing includes illumination correction using background surface estimation, adaptive contrast normalization, denoising via non-local means or bilateral filtering, adaptive-threshold binarization, projection-profile or Hough-based deskew, geometric normalization, and scale harmonization to a target x-height range. In the presence of colored or patterned security paper, the OCR module 106 applies color-space transformations and background suppression to improve foreground separation while preserving thin strokes in signature traces and stamp glyphs.

In some embodiments, the OCR module 106 implements a dual-path recognition pipeline to accommodate machine-printed and handwritten content. A printed-text path employs a convolutional or transformer-based text detector followed by a printed-text recognizer using connectionist temporal classification decoding or attention-based sequence modeling. A handwriting path employs a detector trained on cursive and mixed-script endorsement content and a recognizer incorporating recurrent or transformer layers tuned for variable stroke continuity and ligatures. A script-style selector ranks candidate paths per region using a lightweight classifier so that printed stamps, typed addresses, and cursive endorsements are handled by appropriately specialized recognizers.

In some embodiments, the OCR module 106 performs layout analysis that segments an endorsement region into logical zones including restrictive endorsement text, account identifiers, bank-name lines, payee business-name blocks, signature baselines, stamp-perimeter text, date annotations, and free-form notes. Zone boundaries are produced as polygons with hierarchical relations, enabling downstream modules to apply zone-specific validation rules. Lines detected within a restrictive-endorsement zone are decoded with a lexicon constrained to phrases such as “FOR DEPOSIT ONLY,” “PAY TO THE ORDER OF,” and institution identifiers, while numeric strings in an account or routing zone are decoded with digit-biased priors.

In some embodiments, lexicon-and pattern-constrained decoding is applied to improve robustness in noisy, low-ink, over-stamped, or low-resolution regions. The OCR module 106 integrates finite-state transducer or beam-search decoders with domain dictionaries comprising business names, common abbreviations, postal-address vocabularies, and standard endorsement phrases. Post-decoding validation applies regular-expression and checksum checks across recognized fields, including date-format validation, currency-format normalization, and ABA routing-number check-digit validation. Upon failure of a format or checksum validation, the OCR module 106 triggers targeted re-decode at higher magnification or alternate binarization settings and outputs both original and revised hypotheses with confidence deltas.

In some embodiments, the OCR module 106 outputs token-level confidence measures calibrated to probability space using temperature scaling or isotonic regression fit on held-out endorsement datasets. Confidence calibration enables threshold-based acceptance, selective human review, or dynamic routing to the heuristic validator 132 when recognition certainty falls below configured limits. Line-stability and character-shape variance metrics are computed to assist the fraud detection engine 118 in distinguishing genuine stamp imprints from reconstructed or composited text.

In some embodiments, barcode and symbol decoding is integrated within the OCR module 106 to extract data from one-dimensional barcodes and two-dimensional matrices present in approval stamps or back-office routing labels. Decoded payloads are subjected to the same validation and normalization pipeline to harmonize identifiers and timestamps with the comparison engine 110.

In some embodiments, the OCR module 106 produces raw text and normalized canonical representations. Normalization includes case folding, punctuation standardization, expansion of common abbreviations, address-component parsing, and Unicode normalization to a preferred code-point set. A mapping between canonical tokens and original glyph spans is emitted to enable precise highlight overlays in user interfaces and immutable audit linkage within the tamper-evident audit log generator 134.

In some embodiments, the OCR module 106 supports incremental and streaming operation. As tiles of an endorsement region are processed, partial results are emitted with stable identifiers and ordering hints, enabling early-stage comparison against reference snippets in the issuance file 114 and near real-time notifications through the interbank or inter-entity notification interface 124. A batching scheduler adapts tile size and model selection to hardware constraints, leveraging GPU or vector-accelerated kernels when available.

In some embodiments, personalization and adaptation are supported through bank-or business-specific fine-tuning. The OCR module 106 maintains style profiles that capture typical fonts, stamp layouts, and signature stroke statistics observed for a particular entity. Profiles adjust priors, lexicons, and augmentation parameters during inference to improve recognition on recurring layouts while preserving generalization for unseen formats. Profile selection is driven by upstream hints such as issuer identity, payee identity, or account metadata provided by the comparison engine 110.

In some embodiments, the OCR module 106 provides structured error reporting and re-capture guidance. When quality thresholds cannot be met, explicit failure codes and region-specific diagnostics are returned, including excessive skew, motion blur, glare, cut-off margins, or insufficient resolution for microtext. Diagnostics are consumable by acquisition software to request re-scan or re-capture under adjusted parameters.

In some embodiments, privacy and security controls are embedded within the OCR module 106. Sensitive fields such as account numbers or taxpayer identifiers are masked or tokenized prior to persistence, with reversible detokenization keys held under role-based access controls. Intermediate artifacts are retained only in volatile memory unless audit retention is requested by the tamper-evident audit log generator 134, in which case artifacts are hashed, encrypted, and stored with integrity metadata.

In some embodiments, the OCR module 106 exposes an interface contract including versioned schemas for inputs and outputs, feature flags for model selection, and deterministic seeding to ensure repeatable results across environments. Backward compatibility guarantees are provided so that updates to recognition models do not disrupt downstream modules, and provenance metadata identifying model versions, pre-processing parameters, and confidence-calibration sets used for each inference are reported.

In some embodiments, performance objectives include minimum character accuracy at a specified confidence threshold, latency targets per endorsement region, and throughput scaling under concurrent workloads. Runtime telemetry is published to an audit and monitoring framework to enable continuous quality measurement, drift detection, and scheduled retraining when field distributions evolve due to new stamp templates or seasonal address changes.

One or more embodiments enable the OCR module 106 to transform heterogeneous, noisy endorsement imagery and front-of-document text into reliable, validated, and audit-ready structured data suitable for cross-entity comparison, temporal analysis, and operational decisioning within the fraud detection system 100.

In some embodiments, the ML classifier 108 is configured as a multi-task vision and document-intelligence model operating on endorsement-region crops and, optionally, front-of-document context tiles. The ML classifier 108 generates outputs including authenticity probabilities, similarity scores against reference embeddings, segmentation masks for stamps and signatures, bounding polygons for discovered artifacts, and intermediate feature embeddings consumable by the comparison engine 110 and the fraud detection engine 118.

In some embodiments, the ML classifier 108 can employ a convolutional or transformer-based image encoder to derive spatial feature maps from grayscale or color endorsement crops. Exemplary encoders can include residual convolutional networks, EfficientNet-family encoders, or vision transformers with multi-head self-attention. Encoder outputs feed task-specific heads for classification, detection, and segmentation. A stamp-detection head predicts bounding boxes and classes for printed or rubber-stamp artifacts, a signature-segmentation head produces pixel-level masks to isolate handwritten traces from background, and a text-artifact head estimates likelihood that observed glyphs originate from genuine ink transfer versus reconstructed or composited overlays, enabling detection of cut-and-paste or synthetic endorsements.

In some embodiments, the ML classifier 108 can integrate a metric-learning pathway for signature and stamp comparison. The pathway maps endorsement subregions into a low-dimensional embedding space using a Siamese or triplet architecture trained with contrastive or triplet loss. Given an incoming embedding eg and a reference embedding er from issuance or consortium repositories, the ML classifier 108 computes cosine similarity and applies a calibrated link function to produce a match likelihood. Center loss or ArcFace-style angular margins can be employed during training to improve inter-class separability and intra-class compactness for recurring payees or entities.

In some embodiments, the ML classifier 108 can fuse visual features with OCR-derived tokens and layout coordinates to produce cross-modal representations for endorsement stamps. A document transformer accepts token embeddings, absolute or relative two-dimensional positions, and visual patch embeddings from the endorsement crop, enabling joint reasoning over text strings, stamp geometry, and spatial layout. Cross-attention between visual and textual streams supports detection of inconsistent pairings such as valid stamp-perimeter text surrounding mismatched account numerals or business names.

In some embodiments, the ML classifier 108 can compute geometry and texture descriptors that characterize endorsement authenticity. Computed descriptors include Zernike and Hu moment invariants for stamp contours, local binary patterns and gray-level co-occurrence matrices for ink texture, Fourier descriptors for perimeter regularity, Hough-derived line statistics for alignment, and skeleton-based curvature metrics for signature stroke dynamics. Descriptor vectors are concatenated with deep features and passed to gradient-boosted decision layers or shallow neural heads to improve robustness under low-resolution, blur, or heavy compression conditions.

In some embodiments, the ML classifier 108 can include an anomaly-detection subsystem for conditions lacking sufficient references. The subsystem comprises an autoencoder trained on legitimate endorsement embeddings to learn a manifold of typical signatures and stamp layouts. At inference, reconstruction error or Mahalanobis distance in embedding space indicates novelty, allowing detection of out-of-family endorsements without explicit negative examples. A one-class support vector machine or a normalizing-flow density estimator provides an alternative approach to novelty scoring.

In some embodiments, the ML classifier 108 can expose calibrated probability outputs for each task. Calibration is achieved by temperature scaling, Platt scaling, or isotonic regression fitted on held-out endorsement datasets that include institution-specific distributions. Calibrated scores are consumed by the fraud detection engine 118 for thresholding, weighted aggregation, and human-review routing, with per-task thresholds optionally conditioned by entity style profiles learned from historical items.

In some embodiments, the ML classifier 108 can provide model-interpretability artifacts to support auditability and operational trust. Saliency maps or Grad-CAM heatmaps are produced for visual tasks, highlighting pixels contributing most to a fraud decision. Token-importance weights are produced for cross-modal decisions to identify influential n-grams within stamp text. All explanation artifacts, along with input hashes, model identifiers, and decision vectors, are forwarded to the tamper-evident audit log generator 134 for immutable recording.

In some embodiments, the ML classifier 108 performs streaming and tiled inference to accommodate high-resolution endorsement regions. A tile scheduler coordinates overlap and stride to preserve context while controlling memory usage. Early-exit classifiers return high-confidence decisions without fully processing deeper layers to reduce latency under production loads. GPU, TPU, or vector-accelerated kernels are utilized where available, and mixed-precision inference is enabled under numeric-stability constraints.

In some embodiments, the ML classifier 108 implements adversarial and robustness safeguards. Input canonicalization through JPEG recompression, light random resizing, or bit-depth normalization reduces sensitivity to adversarial perturbations and scanner artifacts. Randomized smoothing or test-time augmentations provide variance estimates for uncertainty reporting. Quality gates interact with the OCR module 106 to trigger re-capture guidance when confidence falls below configured thresholds.

In some embodiments, the ML classifier 108 is trained on institution-and consortium-curated datasets containing endorsement crops and associated labels such as genuine, forged, altered, over-stamped, or missing. Data augmentation simulates real-world degradations including Gaussian blur, motion blur, Poisson noise, ink bleed-through, photocopy halftoning, color-cast variation, JPEG artifacts, over-stamp occlusion, partial crops, and skew. Class imbalance is addressed by focal loss, hard-example mining, or re-weighting strategies. Multi-task learning aggregates detection, segmentation, and classification losses with tunable weights to optimize end-to-end performance.

In some embodiments, training of the ML classifier 108 is performed using institution-and consortium-curated datasets containing endorsement-region crops and, optionally, aligned front-of-document context, with ground-truth labels including genuine, forged, altered, over-stamped, and missing endorsement classes derived from issuance files, verified endorsement specimens, and adjudicated fraud cases. Training inputs are standardized for resolution and color space and are augmented to simulate operational conditions including Gaussian blur, motion blur, Poisson noise, ink bleed-through, photocopy halftoning, JPEG compression artifacts, color-cast variation, over-stamp occlusion, partial crops, and geometric skew. A multi-task objective can be used to jointly optimize classification, detection, and segmentation heads, while a metric-learning objective employing contrastive or triplet loss with ArcFace-style angular margins shapes an embedding space for signature and stamp similarity scoring; class imbalance is addressed by focal loss, cost-sensitive reweighting, and hard-example mining. Post-training calibration is performed using temperature scaling or isotonic regression on a held-out calibration set to align probability outputs with empirical accuracies. Training pipelines can support federated learning across participating entities with secure aggregation of model updates and application of differential-privacy noise to gradients or statistics to bound information leakage, with sensitive tokens masked or tokenized prior to persistence and training execution performed within confidential-computing enclaves when supported by infrastructure. Hyperparameters can be tuned via Bayesian optimization under early stopping and weight-decay regularization, model selection is validated through cross-entity k-fold evaluation and shadow testing on mirrored traffic under statistically controlled promotion criteria, and comprehensive audit metadata, such as, without limitation, dataset identifiers, label provenance, preprocessing profiles, augmentation policies, calibration set descriptors, hyperparameter configurations, and weight checksums, is recorded to provide lifecycle traceability and reproducibility.

In some embodiments, the ML classifier 108 can participate in privacy-preserving training regimes. Federated learning across participating institutions is supported through secure aggregation of model updates, and differential-privacy noise is applied to gradients or statistics to bound leakage risk. Personally identifiable content is masked or tokenized prior to persistence, and training pipelines operate within confidential-computing enclaves where supported by infrastructure.

In some embodiments, the ML classifier 108 emits standardized outputs through a versioned interface contract. Outputs include per-task probabilities, similarity scores, detection boxes, segmentation masks, embeddings, and uncertainty measures. Provenance metadata includes model family, version, training-cohort identifiers, calibration-set identifiers, augmentation profile, and checksum of weights. Backward-compatible schemas allow safe model upgrades without disrupting downstream components such as the comparison engine 110 or the operational actions module 120.

In some embodiments, the ML classifier 108 integrates continuous monitoring and drift detection. Distributional statistics of embeddings, per-class confidence histograms, and false-positive or false-negative signals from downstream adjudication are tracked, with significant drift triggering retraining jobs or threshold re-optimization. Shadow deployment and A/B evaluation compare incumbent and candidate models on mirrored traffic under statistically controlled promotion policies to production.

In some embodiments, the ML classifier 108 coordinates with the heuristic validator 132 for graceful degradation. When image quality or confidence falls below preset limits, heuristic rules based on endorsement-region occupancy, stamp density, and signature presence provide a fallback decision, and items are routed for secondary review with appropriate hold recommendations. All fallbacks and overrides are recorded by the tamper-evident audit log generator 134.

In some embodiments, the ML classifier 108 incorporates entity-specific adaptation through style profiles. Style profiles capture recurrent fonts, stamp-perimeter phrases, typical bounding-box geometries, and signature-stroke statistics for a business or payee. During inference, profile-conditioned priors adjust decision thresholds or gating logic to improve accuracy on recurring layouts while maintaining generalization for previously unseen entities.

In some embodiments, the ML classifier 108 implements secure model lifecycle controls. Signed model packages, checksum verification, role-based deployment permissions, and runtime attestation prevent unauthorized model changes. Encryption of model weights at rest and in transit, together with key management under strict access controls, preserves model integrity across environments.

Collectively, the described embodiments enable the ML classifier 108 to deliver high-fidelity endorsement understanding, robust similarity and anomaly scoring, calibrated probabilities, and auditable explanations, thereby supplying the fraud detection engine 118 and the comparison engine 110 with reliable machine-learned signals that materially improve detection accuracy, reduce false positives, and shorten decision-to-action cycle time across diverse document types.

In some embodiments, the extracted data is transmitted to a comparison engine 110, which evaluates endorsement features and front-of-document elements against reference data stored in an issuance file 114 and a verification repository 116. The issuance file 114 may contain records provided by an originating entity, such as document identifiers, dates, amounts, payee or recipient details, or issuing authority metadata, whereas the verification repository 116 aggregates endorsement imagery, transaction history, and risk data contributed by multiple participating organizations. This dual-layered comparison enhances discrepancy detection by leveraging both local and cross-institutional data.

In some embodiments, the issuance file store 114 serves as an authoritative, time-versioned repository of issuer-provided reference records used to anchor document authenticity comparisons. The issuance file store 114 retains canonical fields describing authorized documents, including identifiers, dates, amounts, payee or recipient data, addresses, and optional signature or endorsement specimens, together with provenance metadata, version tags, and effective-time ranges. The issuance file store 114 exposes normalized schemas and tolerance configurations—such as rounding bands, nickname dictionaries, expected address variants, and stale-dating windows—enabling the comparison engine 110 to perform field-by-field alignment and tolerance-aware matching against features extracted from front and back images. The issuance file store 114 provides snapshot retrieval for time-correct verification at presentment, caching for performance, and integrity and access controls for data trustworthiness. By supplying a consistent baseline for authorized items, the issuance file store 114 reduces false positives, improves discrepancy localization, and supports traceable decisioning through audit-friendly identifiers and version histories recorded downstream by the tamper-evident audit log generator 134.

In some embodiments, the comparison engine 110 queries the issuance file store 114 to retrieve issuer-provided records describing authorized documents, including document identifiers, check numbers, issue dates, monetary amounts, payee or recipient names, payee addresses, and optional signature or endorsement specimens if present, and then normalizes the retrieved records to a canonical schema for field-by-field alignment with features extracted from front and back document images. The comparison engine 110 applies lexicon-and address-parsing normalization to payee strings, currency and date standardization, MICR-format validation, and number-range checks for authorized check sequences, followed by tolerance-aware matching that accommodates issuer-configured rules such as amount rounding tolerances, nickname dictionaries for business names, expected address variants, and stale-dating windows. For each field, the comparison engine 110 computes similarity scores and deterministic pass/fail indicators, generates deltas identifying mismatches or missing fields, and aggregates results into an issuance-consistency score accompanied by reason codes. In some embodiments, the comparison engine 110 can include caching and version metadata from the issuance file store 114 are used to ensure time-correct comparisons against the issuance snapshot in force at presentment time, while access controls and integrity checks verify provenance of the retrieved records. The comparison engine 110 can output data such as, e.g., per-field match status, the issuance-consistency score, and structured rationale, which are forwarded to the fraud detection engine 118 for fusion with temporal, cross-channel, and heuristic signals, and are recorded in the tamper-evident audit log generator 134 for traceability.

In some embodiments, the verification repository 116 can include as a multi-institution, near real-time data source that aggregates endorsement imagery, transaction history, and risk contributions from participating organizations to enable cross-entity verification and validation. Alternatively, or in addition, the verification repository 116 can include any data repository associated with an entity in the consortium, including databases, network-attached storage, cloud storage, among others or any combination thereof. The verification repository 116 expands baseline populations for similarity scoring and anomaly detection, improving separation between legitimate and fraudulent presentments and reducing exploitation of institution-specific gaps by fraudsters. Access is provided through secure application-programming interfaces implementing end-to-end encryption and authentication, with normalized schemas and provenance metadata supporting time-correct, high-integrity comparisons. The verification repository 116 supplies the comparison engine 110 with cross-entity references for endorsement-feature matching and supports the fraud detection engine 118 with calibrated corroboration signals, thereby reducing false positives and elevating detection accuracy. Deployments may operate as a centralized store or as a directory-based routing layer that forwards inquiries to source institutions, with de-duplication, quality controls, and contribution governance enabling consistent, auditable use across institutions.

In some embodiments, the comparison engine 110 interacts with the verification repository 116 through secure interfaces to obtain cross-entity reference signals that augment local issuance-based verification. To do so, in some embodiments, the comparison engine 110 packages endorsement-feature data into a normalized query payload annotated with timestamps, entity identifiers, and privacy-preserving hashes. Endorsement data can include, e.g., comprising OCR tokens, spatial-layout descriptors, and visual embeddings generated by the ML classifier 108, among others or any combination thereof. In some embodiments, using the endorsement data, the comparison engine 110 submits the payload to the verification repository 116 and retrieves historical endorsement imagery and embeddings for relevant payees, reference stamp templates, adjudicated fraud exemplars, negative-file indicators, and transaction-context metadata contributed by participating organizations. The comparison engine 110 can filter returned references for time-correct applicability and de-duplicates entries across sources based on the front check image and/or back check image, among other document-related data or any combination thereof. Accordingly, the comparison engine 110 can perform similarity scoring, e.g., using approximate-nearest-neighbor lookups in embedding space, lexicon-and pattern-constrained string matching for OCR tokens, and spatial-tolerance checks for stamp and signature placement, among other similarity measurement techniques or any combination thereof.

In some embodiments, similarity comparison can be performed in a learned embedding space using cosine or distance metrics, optionally combined with approximate-nearest-neighbor retrieval and probability calibration to yield match likelihoods. In some embodiments, geometric and layout comparison may assess spatial arrangement and shape through alignment and contour metrics, with optional normalization for skew and perspective to stabilize measurements across diverse capture conditions. In some embodiments, appearance and texture comparison can utilize patch-level similarity, correlation, and distributional descriptors of ink or gradient textures to surface visual concordance or deviation. In some embodiments, textual and OCR-based comparison may evaluate normalized tokens and strings with domain-constrained validation, including, without limitation, checksum and format rules for numeric identifiers and postal-standard canonicalization for address components. In some embodiments, stroke-dynamics and sequence comparison can align signature skeletons and endorsement sequences to quantify departures in pen-motion characteristics or ordering cadence. In some embodiments, composite fusion scoring may aggregate heterogeneous comparator outputs under learned or policy-driven weighting to produce a consolidated similarity score accompanied by reason codes and confidence measures, and may incorporate additional comparators, calibration strategies, or policy gates as operational requirements evolve.

Moreover, the comparison engine 110 can apply confidence calibration incorporating repository quality scores, contributor trust weights, and recency decay to produce a cross-entity match score and corroboration status. In parallel, conflict-resolution logic reconciles divergent signals from multiple contributors, while policy gates suppress use of records outside consented scopes. Thereafter, the comparison engine 110 aggregates per-field results into a repository-consistency score with structured reason codes and caches non-sensitive references under strict time-to-live parameters for performance. Finally, the comparison engine 110 forwards scores and rationales to the fraud detection engine 118 for fusion with temporal and cross-channel indicators and records query parameters, provenance metadata, and outcomes in the tamper-evident audit log generator 134 to preserve traceability and support auditability.

In certain embodiments, a fraud detection engine 118 can aggregate inputs from the comparison engine 110 and additional analytical modules. A temporal pattern analyzer 128 evaluates issuance and presentment sequences to identify behavioral anomalies, such as irregular issuance patterns or deviations in endorsement sequences across time. A cross-channel correlation engine 130 integrates data from other transaction channels, such as, e.g., automated clearing house (ACH) transactions, wire transfers, payment card activity, or document lifecycle systems, to identify multi-modal risk patterns. When reference data is incomplete or unavailable, a heuristic validator 132 provides a fallback mechanism by applying rule-based assessments derived from document-format expectations, endorsement-region occupancy, and signature or stamp density.

In some embodiments, the temporal pattern analyzer 128 is configured to model issuance-to-presentment chronology and longitudinal behavior of endorsement-derived features to expose sequence-level irregularities beyond static comparisons. The temporal pattern analyzer 128 constructs entity-and payee-specific baselines using sliding-window statistics, exponentially weighted moving averages, and seasonal decomposition to characterize expected inter-arrival times, day-of-week and month-of-year seasonality, endorsement-sequence ordering, and layout stability for signatures and stamps. In some embodiments, the temporal pattern analyzer 128 can implement change-point and drift detection techniques, including cumulative-sum control charts, Bayesian online change-point inference, Kolmogorov-Smirnov tests on embedding distributions, and Mahalanobis-distance monitoring against historical mean, covariance profiles, to isolate abrupt or progressive deviations in stamp geometry, endorsement lexicon, spatial placement, and token-frequency distributions.

In some embodiments, the temporal pattern analyzer 128 can use one or more time-series models, such as, without limitation, ARIMA, Holt-Winters, state-space/Kalman filters, and recurrent architectures, among others or any combination thereof. The time-series model(s) can generate short-horizon forecasts, with residual analysis producing a calibrated temporal anomaly index and associated reason codes. In some embodiments, the temporal pattern analyzer 128 can use graph-and sequence-based analyses, including Markov-chain transition probabilities, for endorsement-order patterns and sequence-alignment scoring for recurring batch deposits, quantify out-of-family ordering and cadence shifts.

In some embodiments, configuration parameters of the temporal pattern analyzer 128 may be configured for document-type conditioning, holiday and business-calendar adjustments, and adaptive thresholding driven by account tenure and recent volatility. Outputs of the temporal pattern analyzer 128 can include a numeric temporal anomaly score, confidence measures, and contributing-feature attributions consumable by the fraud detection engine 118 for aggregation with cross-modal signals, with intermediate metrics recorded by the tamper-evident audit log generator 134 to support auditability and post-incident analysis.

In some embodiments, the cross-channel correlation engine 130 can be used to fuse endorsement-derived features with transaction streams from additional data channels to expose multi-modal risk conditions that are not apparent within single-source analyses. In some embodiments, the cross-channel correlation engine 130 can use channel inputs, each normalized to a common schema including, e.g., timestamps, counterparties, instrument identifiers, geospatial hints, and risk flags, among others or any combination thereof. The channel inputs can include, without limitation, automated clearing house transactions, wire transfers, payment card activity, lockbox deposits, and document-lifecycle events,. Feature-level joins can be performed across shared keys and probabilistic linkages, with alignment gates enforcing temporal proximity, entity-consistency checks, and value-range plausibility.

In some embodiments, the cross-channel correlation engine 130 can use one or more correlation methods including, e.g., Bayesian evidence aggregation, graph-based propagation over entity and account networks, etc., and ensemble scoring that weights channel-specific indicators using learned or policy-driven coefficients. In some embodiments, correlation methods can normalize heterogeneous signals to a common schema, align events across sources under temporal and entity-consistency gates, and aggregate evidentiary weight to produce composite risk measures. Normalization harmonizes identifiers, timestamps, value ranges, and categorical flags to enable feature-level joins across shared keys or probabilistic linkages. Alignment enforces proximity windows, counterpart consistency, and plausibility constraints to suppress spurious associations. Aggregation employs Bayesian evidence combination, graph-based propagation over entity and account networks, and ensemble scoring that weights channel-specific indicators under learned or policy-driven coefficients. Conflict-resolution and de-duplication logic attenuate echo effects caused by repeated alerts or correlated upstream detectors, while calibration procedures map composite outputs to precision-recall targets for operational decision thresholds. Streaming execution supports incremental recomputation under sliding windows with quality gates for missing-data imputation and outlier suppression, yielding a stable cross-modal correlation score accompanied by uncertainty measures and structured reason codes.

In some embodiments, the cross-channel correlation engine 130 can produce outputs such as, e.g., a numeric cross-channel correlation score, uncertainty measures, and structured reason codes identifying contributing signals, all consumable by the fraud detection engine 118 for aggregation with endorsement similarity and temporal anomaly indices, and recorded by the tamper-evident audit log generator 134 to support traceability and post-incident analysis.

In some embodiments, the heuristic validator 132 provides can be used for a rule-based assessments when reference data are incomplete, unavailable, or of insufficient confidence, and also provides corroborative checks under normal operating conditions. The heuristic validator 132 evaluates endorsement-region occupancy, stamp density, signature presence, required-phrase detection for restrictive endorsements, spatial alignment of endorsement elements relative to pre-defined zone boundaries, and minimum-contrast and stroke-width metrics indicative of genuine ink transfer. Additional checks include proportion-of-coverage thresholds within the endorsement zone, inter-line spacing regularity, baseline straightness for printed text, stamp-perimeter symmetry, and consistency between OCR token classes and expected field formats, including date, routing-number, and account-number patterns. Rule outcomes are aggregated through a weighted scoring function that incorporates OCR confidence measures and ML-classifier uncertainty, producing a calibrated heuristic risk score and categorical flags identifying missing endorsement, malformed stamp geometry, anomalous density, or out-of-zone placement. Configuration parameters are document-type specific and are tunable per institution or business profile to accommodate recurring layouts and operational tolerances, with adaptive reweighting driven by drift and adjudication feedback from downstream review queues. Quality-gating functions generate recapture guidance when skew, glare, truncation, or sub-threshold resolution is detected, and provide deterministic fail codes consumable by acquisition software. Outputs include a pass/fail indication, a recommended operational action for the operational actions module 120, and structured rationale metadata recorded by the tamper-evident audit log generator 134 to support explainability, regulatory audits, and post-incident analysis.

Upon detecting a discrepancy, the fraud detection engine 118 communicates with an operational actions module 120 to trigger appropriate responses. In some embodiments, the fraud detection engine 118 aggregates outputs from the temporal pattern analyzer 128, the cross-channel correlation engine 130, and the heuristic validator 132 through a calibrated fusion framework that converts heterogeneous indicators into a common decision space. The temporal pattern analyzer 128 contributes a temporal anomaly score with confidence and reason codes describing sequence-level deviations; the cross-channel correlation engine 130 contributes a cross-modal correlation score with uncertainty measures and contributing-signal metadata; the heuristic validator 132 contributes a heuristic risk score with categorical flags identifying rule-based violations such as missing endorsement, malformed stamp geometry, anomalous density, or out-of-zone placement.

In some embodiments, the fraud detection engine 118 can use a normalization stage that maps each score to a probability-calibrated range using stored calibration curves conditioned by document type and entity style profiles, while uncertainty measures are translated into reliability weights.

In some embodiments, the fraud detection engine 118 can use a fusion stage to apply weighted aggregation to compute a composite risk measure accompanied by an aggregate confidence level and merged reason codes. In some embodiments, the weighted aggregation can include, without limitation, Bayesian evidence combination, learned ensemble stacking, or policy-driven linear weighting, among others or any combination thereof. The fusion stage combines outputs from multiple analytical modules, including temporal anomaly scores from the temporal pattern analyzer, cross-channel correlation scores from the cross-channel correlation engine, and heuristic risk scores from the heuristic validator. Each input is normalized to a probability-calibrated range and assigned a reliability weight based on its confidence level and relevance to the specific transaction context. The weighted aggregation process utilizes methodologies such as Bayesian evidence combination, ensemble stacking, or policy-driven linear weighting to synthesize these diverse indicators into a unified composite risk score. The composite score is accompanied by an aggregate confidence level and structured reason codes, enabling precise and actionable decision-making. By employing this multi-faceted approach, the fraud detection engine 118 supports robust detection of fraudulent activities while reducing false positives, thereby facilitating both automated and human-in-the-loop operational workflows.

In some embodiments, the fraud detection engine 118 can use veto and tie-break rules allow categorical flags from the heuristic validator 132 to override low-risk numeric aggregates under defined safety constraints, and temporal or cross-channel indicators exceeding institution-specific ceilings trigger escalation gates regardless of composite score. In some embodiments, the tie-break rules ensure that significant risk indicators, such as missing endorsements, malformed stamp geometry, or out-of-zone placement, are not overlooked due to low composite risk scores derived from aggregated numeric data. For instance, if the heuristic validator identifies a high-confidence categorical anomaly, such as a missing restrictive endorsement, the veto mechanism can supersede the overall low-risk score and escalate the transaction for further review. Similarly, tie-break rules are applied when multiple risk indicators yield conflicting results, enabling the system to prioritize specific high-risk categories over less significant factors. This approach ensures that the fraud detection system remains robust against sophisticated fraud attempts that may evade detection through numerical aggregation alone, thereby reducing false negatives and enhancing overall system reliability.

In some embodiments, the fraud detection engine 118 can use adaptive thresholding to select decision cutoffs based on recent drift metrics, account tenure, and volatility bands, yielding one of multiple outcomes including approve, queue for human-in-the-loop review, or discrepant-fraud determination. In some embodiments, the drift metrics can be used to monitor changes in data distributions over time, ensuring that the system remains responsive to evolving fraud patterns. In some embodiments, the account tenure provides a contextual factor, allowing thresholds to be adjusted based on the historical stability and activity of the account in question. In some embodiments, the volatility bands, derived from transaction frequency and value fluctuations, further refine the decision-making process by accounting for expected variations in account behavior. By integrating these parameters, the system can yield one of multiple outcomes, including automatic approval for low-risk transactions, queuing for human-in-the-loop review for borderline cases, or flagging transactions as discrepant for potential fraud determination. This approach enhances detection accuracy while minimizing false positives and operational inefficiencies.

In the event that the fraud detection engine 118 determines no fraud is detected, the system proceeds to approve the transaction without triggering any additional operational responses. For example, the fraud detection engine 118 aggregates inputs from various analytical modules, including the temporal pattern analyzer 128, cross-channel correlation engine 130, and heuristic validator 132, and evaluates the results against pre-configured thresholds. If all indicators fall within acceptable ranges, the engine generates an approval output, which is transmitted to the operational actions module 120. This output may include instructions to process the check through standard clearing channels, update transaction logs, and notify relevant stakeholders of the successful validation. Additionally, the system records the decision in the tamper-evident audit log generator 134 to ensure traceability and compliance with regulatory requirements. By streamlining the approval process for non-fraudulent transactions, the system minimizes processing delays and maintains operational efficiency.

In some embodiments, upon detecting a potential fraud event, the fraud detection engine 118 aggregates outputs from various analytical modules, including the temporal pattern analyzer, cross-channel correlation engine, and heuristic validator, to generate a composite risk score and associated confidence level. Based on the severity and type of detected discrepancy, the fraud detection engine 118 triggers one or more operational responses through the operational actions module 120. These responses may include placing a funds hold on the suspect transaction, rerouting the check into one or more exception processes (e.g., including exception review, processing and/or clearing) for expedited review, or initiating a breach-of-warranty claim against the presenting financial institution. The engine employs adaptive thresholding to calibrate decision cutoffs based on recent data trends, account history, and transaction volatility, ensuring that responses are tailored to the specific risk profile of the transaction. In some embodiments, these actions may include initiating a breach of warranty claim (e.g., against the depositing entity, such as the presenting financial institution, issuer or other, or any combination thereof), placing a data or funds hold, routing the document into an exception path for expedited review, or initiating a claim or notification to a receiving counterparty. The operational actions module 120 ensures that analytical outcomes are translated into enforceable measures, thereby reducing latency between detection and containment.

In some embodiments, to ensure transparency and traceability, the fraud detection system 100 includes a tamper-evident audit log generator 134, which cryptographically hashes analytical steps, intermediate features, and response decisions. Resulting logs are stored in an immutable format to support regulatory compliance, model governance, and post-incident analysis. In certain embodiments, an interbank or inter-entity notification interface 124 facilitates secure transmission of fraud alerts and recommended actions to other organizations, enabling coordinated responses to fraudulent activities across jurisdictions or platforms.

Accordingly, the integration of these components within the fraud detection system 100 provides a comprehensive solution for identifying and mitigating document fraud. By combining endorsement-region analysis, OCR module 106, ML classifier 108, temporal analysis 128, cross-channel correlation engine 130, and multi-institutional data sharing, the fraud detection system 100 enhances detection accuracy, reduces false positives, and improves operational efficiency across diverse document types, with checks serving as a representative implementation.

Indeed, in some embodiments, the system of FIG. 1 delivers technical improvements over existing fraud detection technologies by expanding observable evidence, increasing signal quality, and fusing heterogeneous analytics into calibrated, enforceable decisions. Two-sided acquisition and endorsement-region extraction raise signal-to-noise ratio by isolating high-evidentiary content from the back image, while synchronized processing of front and back images reduces omission of endorsement-derived indicators relative to front-only workflows. The OCR module 106 converts noisy, mixed-script endorsement imagery into validated, zone-aware structured tokens with checksum and format verification, thereby producing machine-interpretable features that withstand low-ink, over-stamp, and compression artifacts. The ML classifier 108 contributes multi-task vision outputs, including detection, segmentation, and authenticity probabilities, together with metric-learned embeddings and calibrated anomaly scores, enabling fine-grained similarity matching and out-of-family detection not achievable with rule-based engines.

The comparison engine 110 further delivers technical improvements by combining time-versioned issuance records from the issuance file store 114 with cross-entity references from the verification repository 116. Learned-embedding metrics, geometric/layout comparators, appearance/texture measures, and OCR-string comparators are calibrated and reconciled with contributor-quality weights, recency decay, and conflict resolution to produce repository-and issuance-consistency scores with reason codes. The temporal pattern analyzer 128 adds longitudinal sensitivity through change-point detection, seasonal decomposition, and forecast-residual analysis, exposing sequence-level anomalies that static snapshot checks miss. The cross-channel correlation engine 130 integrates endorsement signals with ACH, wire, card, lockbox, or document-lifecycle data under Bayesian, graph-based, and ensemble methods, while alignment gates, de-duplication, and precision-recall calibration suppress echo effects and spurious joins. The heuristic validator 132 supplies deterministic safeguards based on occupancy, density, phrase detection, geometry, and zone alignment, enabling graceful degradation when references are sparse and providing categorical flags for safety-critical conditions.

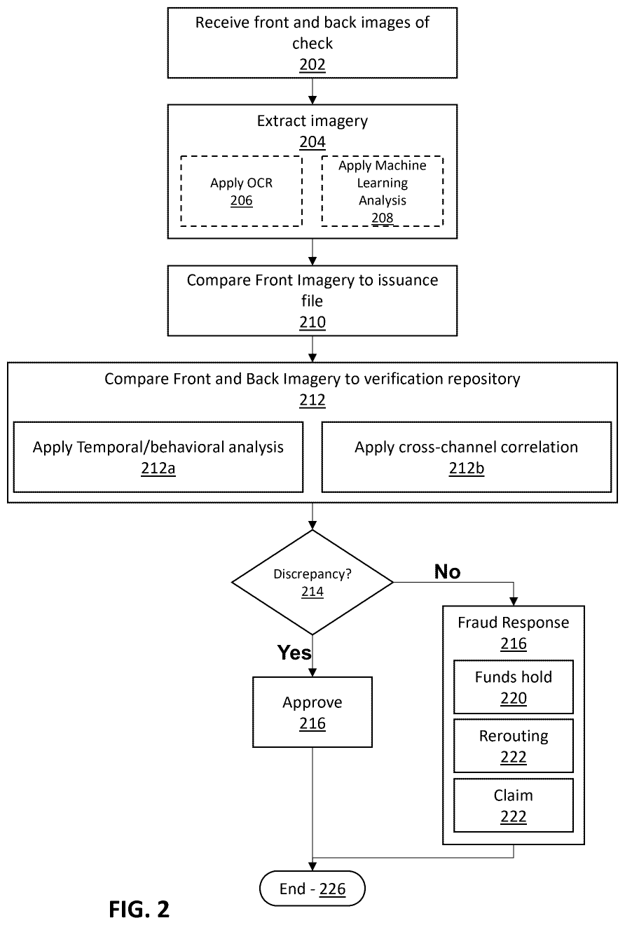

FIG. 2 illustrates a flowchart of a fraud detection process for analyzing check images, identifying discrepancies, and triggering appropriate responses in accordance with one or more embodiments of the present disclosure. The process integrates multiple analytical steps to ensure comprehensive fraud detection and operational response across various data sources and validation layers.

In some embodiments, at step 202, the fraud detection system receives front and back images of a check, where the front image may include transaction-relevant fields such as payee name, date, and amount, and the back image may include endorsement imagery comprising handwritten signatures and endorsement stamps. The received images serve as the primary input for the fraud detection system, enabling analysis of both obverse and reverse sides of the check within a unified processing workflow.

In some embodiments, at step 204, the system extracts endorsement imagery from the back image of the check by isolating the endorsement region, which may include handwritten signatures, printed or stamped endorsements, and alphanumeric endorsement data. At step 206, the extracted endorsement imagery is processed using OCR and machine learning analysis 208. The OCR module converts visual data into structured textual elements, while the machine learning analysis module identifies patterns, anomalies, and potential manipulations in the endorsement imagery based on trained models.

In some embodiments, at step 210, the extracted and analyzed front of check data is compared to an issuance file 114 provided by the check issuer. The issuer populates the fields on the front of the check, and then generates an issuance file containing reference data such as such as check number, amount, payee name, date, and other pertinent details. This comparison provides an initial layer of validation to confirm alignment between the presented check and the issuer's records. In some embodiments, step 210 can include other comparisons as well or instead, such as comparisons of the front of check data against internal or external data repositories, including the payee bank's repository or other repositories or any combination thereof. Thus, even where some entities may not submit data to an issuance file, the fraud detection can proceed to verify the front of check data.

In some embodiments, at step 212, the process advances to comparison against the verification repository 116 aggregating endorsement imagery, transaction history, and risk data contributed by one or more financial institutions of the consortium. The verification repository can refer to a repository hosted for a broader consortium and/or group of entities (e.g., banks, customers, merchants, payment processor, or other entities and/or financial institutions or any combination thereof), or may refer to a repository of a particular bank. Thus, step 212 can include access to any one or more repositories across a group of entities. Examples of access to other verification repositories can include, e.g., peer-to-peer data access between two or more entities (e.g., where two or more financial institutions, or payment processors deploy verification repositories accessible via a network set up to enable the inquiry of by each participating entity to the validity or risk based on the check routing number), one or more federated data repositories (e.g., orchestrated according to via orchestration logic of one or more computer interfaces such as APIs), distributed ledger-based data repository of one or more entities, a consortium model where entities and/or financial institutions participate in a membership construct with shared data stores of information that is used to respond with the same risk outputs and operational action recommendations, among others or any combination thereof. For example, in a federated data repository, one or more repositories may be hosted throughout the consortium with a central entity, such as the Federal reserve bank, that may employ orchestration of API calls and responses with, between and/or amongst the various institutions for whom the Federal Reserve Bank processes items. In another example, more limited and/or targeting queries can be directed via peer-to-peer exchanges, e.g., between a payer and a payee bank, via one or more connections and/or networks established between the associated entities.

At step 212a, temporal or behavioral analysis 128 can be applied to identify anomalies in issuance and presentment patterns, including irregular issuance-to-presentment timelines and where there may be multiple endorsements on the document, endorsement sequence ordering. At step 212b, cross-channel correlation engine 130 can align the check's data with transaction streams from other payment channels, such as automated clearing house transactions, wire transfers, and payment card activity. These multi-modal analyses furnish a cross-entity validation layer that enhances detection of fraudulent activities not apparent from the issuance file alone based on data aggregated in the verification repository (e.g., verification repository 116).

In some embodiments, at decision node 214, the system determines whether a discrepancy exists based on the results of the issuance file comparison, repository validation, temporal analysis, and cross-channel correlation. In some embodiments, the repository validation can include querying one or more bank-related repositories. Such repositories can include one or more intra-bank repositories at the bank of the payee and/or the issuer, one or more consortium repositories having data shared across a consortium of banks, federated repositories of one or more banks, distributed ledger-based repositories (e.g., blockchain), or other repository or any combination thereof. If no discrepancies are detected, the process proceeds to step 216, where the check is approved for further processing, including updating transaction logs and notifying relevant stakeholders. If a discrepancy is identified, the process transitions to step 218, where a fraud response is triggered.

In some embodiments, a fraud response at step 218 may include one or more operational actions, such as placing a funds hold at step 220, rerouting the check into one or more exception processes (e.g., including exception review, processing and/or clearing) for expedited review at step 222, or initiating a breach-of-warranty claim against the presenting financial institution at step 224. These actions are configured to mitigate potential losses and ensure compliance with regulatory requirements.

The process concludes at step 226, marking the end of the fraud detection workflow. Integration of multiple layers of analysis and validation provides a robust mechanism for detecting and responding to fraudulent check activities, thereby enhancing the accuracy and efficiency of fraud prevention measures in financial transaction environments.

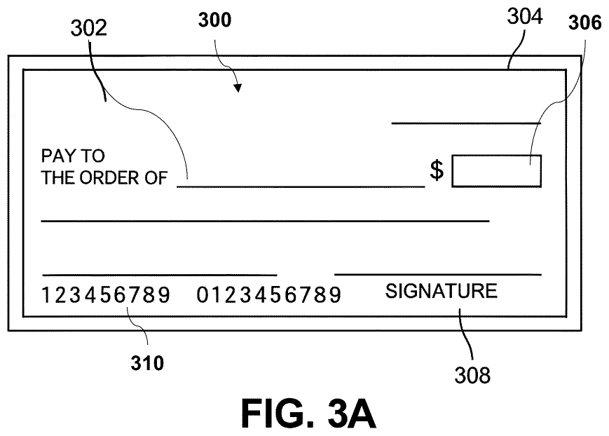

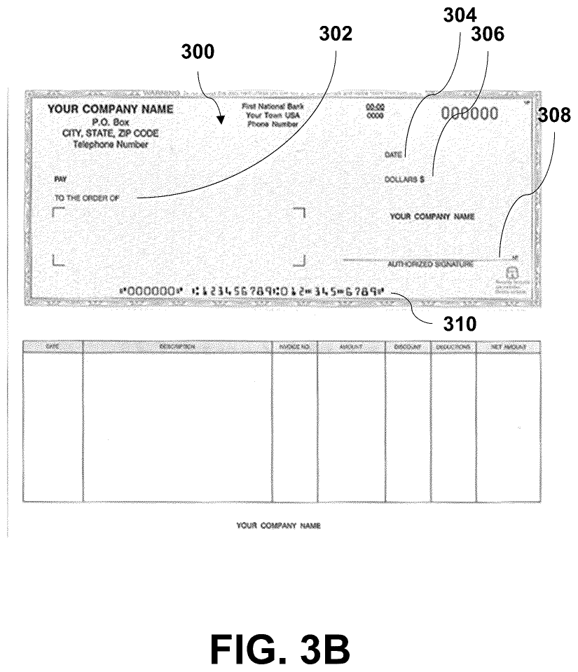

FIG. 3A and FIG. 3B illustrate schematic representations of a check 300, where FIG. 3A depicts a consumer check example and FIG. 3B depicts a business check example, depicting data fields significant for validation and fraud detection processes. In FIG. 3, the fraud detection systems described herein are configured to analyze both front and back images of checks, with each image examined to identify potential fraudulent activities. Each data field described below is parsed to support thorough check authentication.

In some embodiments, a payee line 302 is provided as a designated area for inscription of the name, address of the intended recipient of the check. The payee line 302 serves as a primary field for verifying transaction legitimacy, identifying the individual or entity authorized to receive payment. Alteration or replacement of the payee name and/or payee address to redirect funds to unauthorized parties is flagged as a potential fraud indicator.

In some embodiments, a date field 304 is provided to indicate the date of check issuance. The date field 304 is utilized for verification of check timeliness and detection of discrepancies in the issuance-to-presentment timeline. Temporal analysis of the date field 304 enables identification of anomalies such as backdating or postdating, which may signify fraudulent intent.

In certain embodiments, an amount field 306 specifies the monetary value of the check. The amount field 306 is validated for consistency with issuer reference data, including issuance files 114 and payment instructions. Unauthorized modification of the amount field 306, such as inflation of the check value, is detected through validation protocols.

In certain embodiments, a drawer signature 308 is provided as the authorized signature of the individual or entity issuing the check. The drawer signature 308 functions as an authentication mechanism, confirming issuer intent to authorize payment. Consistency of the drawer signature 308 with stored reference signatures is analyzed to identify potential forgeries or signature alterations.

In certain embodiments, a magnetic ink character recognition (MICR) line 310 is provided at the bottom of the check 300, including machine-readable information such as bank routing number, account number, and check number. The MICR line 310 is utilized in automated check processing and contributes to authenticity verification. Inconsistencies in the MICR line 310, including modified account numbers or check numbers, are regarded as signs of fraudulent activity.

Integration of the payee line 302, date field 304, amount field 306, drawer signature 308, and MICR line 310 within the fraud detection systems described herein enables thorough validation of business checks. Analysis of these fields collectively forms the foundation for advanced fraud detection techniques, including optical character recognition (OCR) 106, ML classifier 108, and heuristic validation 132, thereby providing robust protection against check-based fraud.

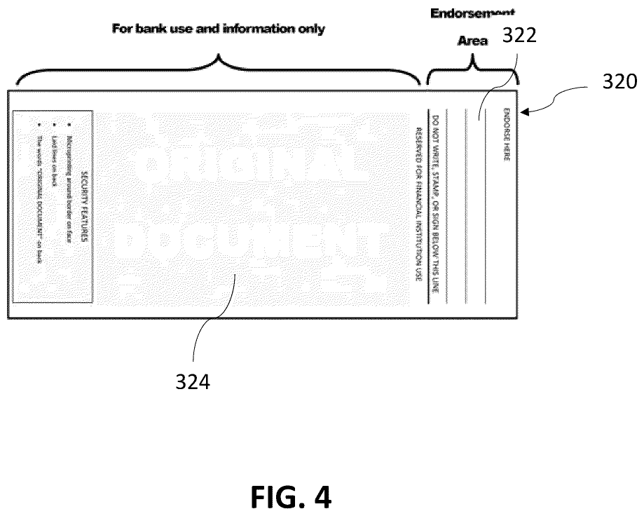

FIG. 4 illustrates a representative configuration of a check processing architecture in which a region for an endorsement 322 and a region for bank processing data 324 of a check 320 is configured for fraud detection and validation. The region for the endorsement 322 which can include a handwritten endorsement and/or a business endorsement stamp, where these components collectively form endorsement imagery subject to authenticity verification.

In some embodiments, the handwritten endorsement 322 comprises a signature of a payee or an authorized individual, signifying approval for deposit or cashing of the check 320. The handwritten endorsement 322 provides a distinct, identifiable marker suitable for comparison against reference datasets, including stored signature specimens, historical endorsement records, and multi-institution repositories 116, to validate transactions and detect anomalous patterns.

In some embodiments, the business endorsement stamp can include structured alphanumeric information, such as a business name, a restrictive endorsement phrase, and an account number. The business endorsement stamp restricts negotiability to a designated account, supplies additional verification data, and ensures compliance with banking regulations. Inclusion of a restrictive phrase, such as “FOR DEPOSIT ONLY,” further limits potential for fraudulent misuse by requiring deposit into a specified account.

In some embodiments, the region for the endorsement 322 and the region for the bank processing data 324 can be isolated and analyzed using optical character recognition (OCR) module 106 and machine learning (ML) classifier 108. These technologies extract and interpret textual and graphical features of the handwritten endorsement 322, bank processing data 324 and/or the business endorsement stamp. Extracted data is compared against trusted reference sources, including issuance files 114, historical transaction records, and multi-institution repositories 116, to identify forgeries, alterations, or counterfeit elements. Incorporation of both the handwritten endorsement 322 and the business endorsement stamp into the analytic pipeline enhances fraud detection capabilities, reduces risk of unauthorized transactions, and improves overall security of the check processing system.

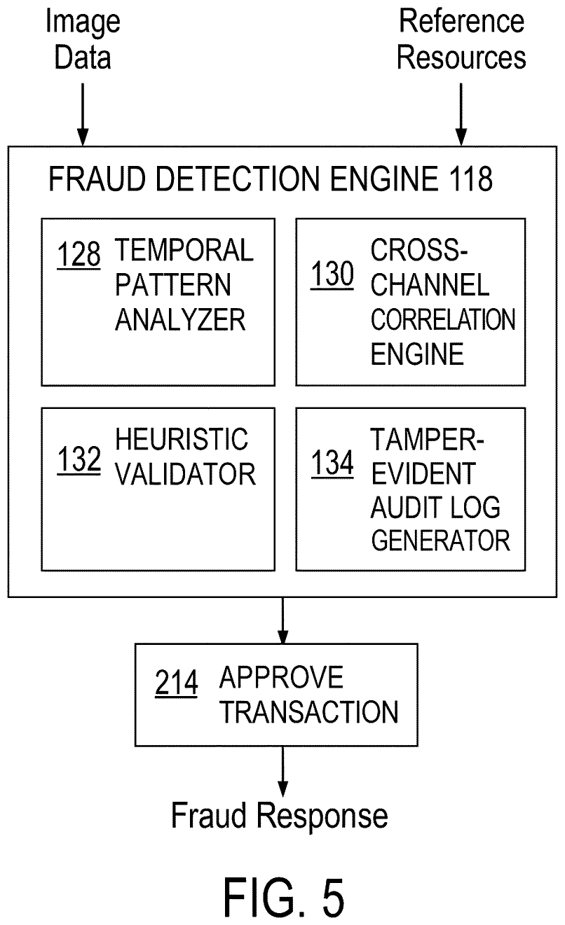

FIG. 5 illustrates a fraud detection engine 118 configured for comprehensive analysis and operational response to potentially fraudulent activities. The fraud detection engine 118 incorporates a temporal pattern analyzer 128, a cross-channel correlation engine 130, a heuristic validator 132, and a tamper-evident audit log generator 134, each contributing distinct analytical and traceability functions.

In some embodiments, the temporal pattern analyzer 128 is configured to evaluate transaction chronology and behavioral patterns, including issuance-to-presentment timelines, endorsement sequence ordering, and transaction frequency. Time-series models and statistical techniques are applied to detect deviations from expected patterns, such as abrupt changes in endorsement geometry or irregular transaction sequences, which may indicate fraudulent activity.

In some embodiments, the cross-channel correlation engine 130 is configured to integrate data from multiple transaction channels, including automated clearing house transactions, wire transfers, and payment card activity. By aligning endorsement anomalies with risk factors from these channels, the cross-channel correlation engine 130 generates compound risk indicators, thereby enhancing detection of fraud that may not be apparent from a single data source and improving overall signal robustness.

In some embodiments, the heuristic validator 132 provides rule-based assessment when reference data is incomplete or unavailable. Endorsement-region characteristics, including stamp density, signature presence, and spatial alignment of endorsement elements, are evaluated against predefined rules. The heuristic validator 132 identifies anomalies such as missing endorsements, malformed stamp geometry, or out-of-zone placement, and generates a calibrated heuristic risk score to support effective operation in data-limited scenarios.

In some embodiments, the tamper-evident audit log generator 134 is configured to create immutable records of analytical steps, intermediate features, and response decisions. Cryptographic hashing of these records ensures traceability and compliance with regulatory requirements, supporting post-incident analysis, model governance, and interbank dispute resolution through a transparent and verifiable audit trail.

Outputs of the fraud detection engine 118 can be processed through a component to approve the transaction (step 216), which aggregates results from the temporal pattern analyzer 128, the cross-channel correlation engine 130, the heuristic validator 132, and the tamper-evident audit log generator 134. In some embodiments, the approve transaction component determines whether a transaction is to be approved or flagged for further action. In the event of detected discrepancies, the fraud detection engine 118 generates a fraud response, including operational actions such as placing a funds hold, rerouting the transaction for manual review, or initiating a breach-of-warranty claim.

Integration of the temporal pattern analyzer 128, the cross-channel correlation engine 130, the heuristic validator 132, and the tamper-evident audit log generator 134 within the fraud detection engine 118 yields a robust and scalable solution for detecting and mitigating fraudulent activities in financial transactions. The combined architecture achieves high detection accuracy, reduced false positives, and enhanced operational efficiency through systematic application of temporal analysis, cross-channel correlation, heuristic validation, and audit logging.

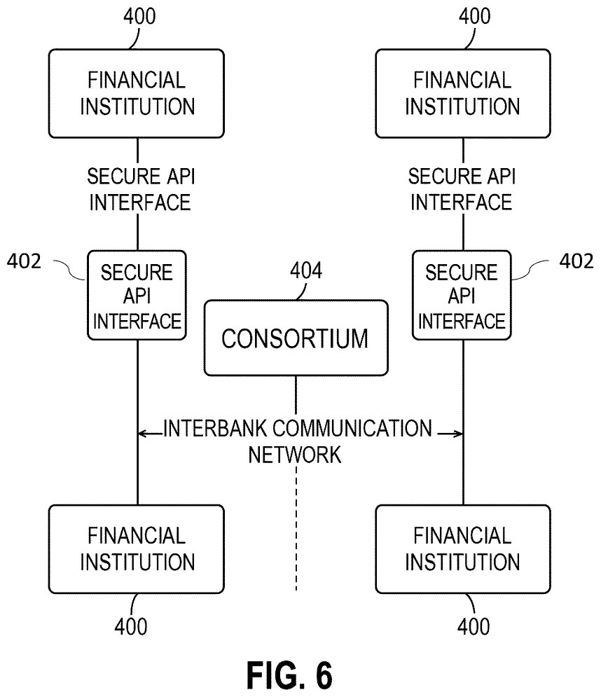

FIG. 6 illustrates an example of networked fraud detection across a network of banks, the example including a consortium-based interbank communication system configured to enable secure data exchange among financial institutions 400. The consortium-based interbank communication system leverages a centralized consortium 404 that aggregates endorsement imagery, transaction history, and risk data contributed by participating financial institutions 400, thereby facilitating collaborative fraud detection and cross-institutional validation processes.

In some embodiments, the consortium 404 can provide a centralized repository or coordination hub that manages and stores shared data artifacts, including endorsement imagery, transaction history records, and risk metrics. The unified data store maintained by the consortium 404 enables verification procedures that enhance detection of fraudulent activities not apparent within a single institution's dataset.

In some embodiments, the consortium 404 maintains a unified data store that consolidates endorsement imagery, derived feature artifacts, transaction context, and risk contributions received from participating financial institutions. The unified data store implements normalized, versioned schemas that represent raw assets such as front and back document images, endorsement-region crops, and barcode payloads, as well as structured derivatives including OCR tokens with spatial coordinates, visual embeddings generated by document-intelligence models, geometry descriptors, contributor quality scores, and adjudication outcomes. Time-versioned records with effective-time ranges and provenance metadata enable time-correct comparisons at presentment, while immutable event logs preserve source identifiers, submission timestamps, and cryptographic content hashes for lineage and integrity verification. De-duplication routines reconcile identical or near-duplicate items across multiple contributors using perceptual hashing and layout fingerprints, and recency and decay parameters weight references according to contribution freshness.

In some embodiments, the unified data store supports multi-modal indexing and retrieval to serve low-latency validation queries and high-throughput analytics. Vector indices index metric-learned embeddings for approximate-nearest-neighbor lookup of signatures and stamps, while relational and document indices support deterministic joins across identifiers, dates, routing attributes, and tokenized text. Hybrid query planners orchestrate embedding search, geometric tolerance checks, and token-level matchers under common query contracts exposed by secure interfaces 402. Caching layers with strict time-to-live parameters accelerate repeated access to hot references, and snapshot isolation ensures consistent reads across concurrent workloads. Horizontal partitioning by institution, region, and time window facilitates scalable ingestion and query parallelism, and active active replicas with consensus protocols provide high availability and disaster recovery.

In some embodiments, the unified data store enforces robust data governance and privacy controls. Role-based access control, attribute-based policies, and purpose-limitation tags govern query scope, while consent flags and jurisdictional labels restrict data use to permitted contexts. Sensitive fields such as account numbers and personally identifiable information are masked or tokenized before persistence, and encryption protects records at rest and in transit with institution-managed keys and periodic key rotation. Differential-privacy noise may be applied to aggregated analytics outputs, and confidential-computing enclaves may host select processing paths to limit exposure of raw artifacts during model adaptation or cross-entity analysis. Contribution agreements define retention windows, deletion workflows, and redress procedures, and audit trails record every read and write with actor identity, purpose code, and result summary to support regulatory and contractual obligations.

In some embodiments, the unified data store attaches quality and trust metadata to each contributed artifact. Quality scores capture image resolution, focus, noise level, skew, and OCR confidence distributions, while trust weights reflect contributor accreditation, historical accuracy, adjudicated error rates, and recency. Policy engines incorporate these attributes into calibration pipelines so that repository-consistency scores and match likelihoods reflect both intrinsic similarity and source reliability. Conflict-resolution logic reconciles divergent references by ranking contributors, applying temporal precedence rules, and, where needed, preserving parallel hypotheses with explicit uncertainty measures for downstream fusion.

In some embodiments, the unified data store supports both online and offline computation. Streaming ingestion pipelines validate schemas, compute embeddings, update indices, and emit governance events in near real time, enabling low-latency cross-entity verification during deposit or clearing. Batch analytics jobs aggregate cohort statistics, train or recalibrate models under federated or privacy-preserving regimes, and produce drift and coverage metrics for participating institutions. Through these capabilities, the unified data store furnishes a stable, auditable, and performance-optimized foundation for cross-entity endorsement comparison, anomaly detection, and operational corroboration within the consortium 404.

Each financial institution 400 connects to the consortium 404 via a secure API interface 402. The secure API interface 402 implements encrypted and authenticated communications, preserving integrity and confidentiality of all data exchanges and ensuring compliance with regulatory requirements. While APIs are described and depicted here, any other software and/or hardware interface technologies may be employed, including, e.g., AMQP/JMS/RabbitMQ, Kafka/Pulsar/NATS for pub/sub and queue-based decoupling with durable, at-least-once delivery, webhooks or callback endpoints to push disposition events and alerts (optionally via brokered relay rather than direct HTTP), standardized financial messaging networks (e.g., SWIFT FIN/MX (ISO 20022) for cross-border, high-assurance signaling; FedLine channels, CHIPS/TCH interfaces for domestic clearing context metadata, ACH/NACHA addenda, lockbox files, and bank statement BAI2/ISO CAMT messages to share corroboration signals via established banking rails, etc.), among others or any combination thereof.

The interbank communication network supports real-time or near-real-time data transmission between financial institutions 400 and the consortium 404. The network architecture accommodates high data volumes and maintains low latency, enabling timely detection and response to anomalous or fraudulent activities. In some embodiments, the interbank communication network employs flexible topologies that support centralized, federated, and peer-to-peer interaction models. A hub-and-spoke configuration can route inquiries and responses through a consortium-operated coordination layer for simplified integration and global visibility. A directory-based federation can enable direct institution-to-institution exchanges for low-latency lookups while preserving a central registry for discovery and policy. A publish/subscribe overlay can distribute alerts, adjudication outcomes, and recall advisories to authorized participants, supporting rapid, coordinated responses across entities. In some embodiments, the interbank communication network provides secure, versioned interfaces that accommodate synchronous request/response for real-time verification and asynchronous submission for batch reconciliation. Interface contracts can define canonical schemas and evolution policies to maintain compatibility as capabilities expand. Security controls can enforce mutual authentication, transport and payload encryption, and role-and attribute-based authorization. Privacy and governance measures can apply data minimization, consent and purpose tagging, and jurisdiction-aware routing to satisfy regulatory and contractual obligations.

The system supports multiple deployment models, including a fully centralized repository model in which all shared data is stored within the consortium 404, and a directory-based routing model that forwards data inquiries to the appropriate institution's local repository. Expansion of the baseline population for similarity scoring and anomaly detection generates calibrated corroboration signals that enhance decision-making processes within each financial institution 400.

Accordingly, in some embodiments, the secure interbank communication system can employ a consortium-based architecture to mitigate fraud risk across financial institutions 400. Integration of secure API interfaces 402 and a centralized consortium 404 enables collaborative detection, reduces financial losses, and improves the security posture of the financial ecosystem.

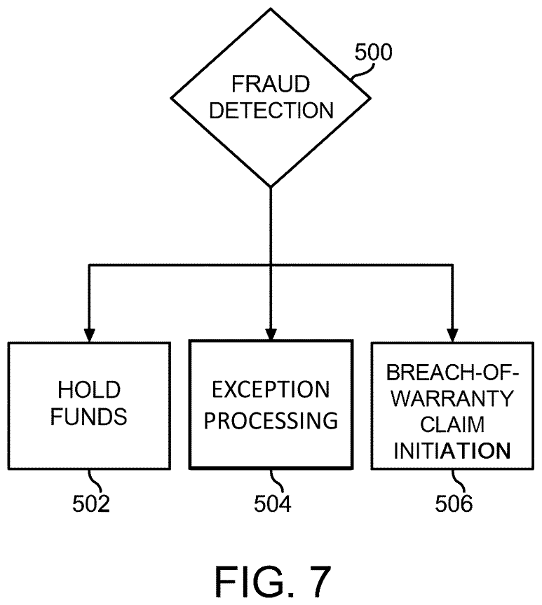

FIG. 7 illustrates a flowchart of a fraud detection decision process detailing operational responses triggered upon detection of fraudulent activity in accordance with one or more embodiments of the present disclosure. The process initiates with a fraud detection step 500, representing the cumulative output of analytical modules and techniques including, without limitation, optical character recognition module 106, ML classifier 108, temporal pattern analysis 128, cross-channel correlation engine 130, and heuristic validation 132. These modules evaluate the authenticity of a presented document item by analyzing front and back images and comparing extracted features to trusted reference data.

Upon detection of a discrepancy or fraudulent activity at step 500, the process advances to one or more operational responses, such as hold funds 502, one or more exception processes (e.g., exception review and clearing) 504, breach-of-warranty claim initiation 506, among others or any combination thereof.

In some embodiments, which action to take may be determined at step 500 by applying a policy-driven decision framework that consumes outputs from fraud detection (e.g., by the fraud detection engine 118) and/or with contextual and regulatory constraints. Inputs to the analysis can include a composite risk score, an aggregate confidence level, structured reason codes, uncertainty measures, categorical flags produced by heuristic validation, and corroboration status derived from issuance-and repository-consistency scores. Additional contextual inputs can include transaction attributes (amount, channel, instrument class), account metadata (risk rating, tenure, limits, historical volatility), customer and counterparty status (alerts, stop-pay instructions, negative-file hits), and timing constraints (regulatory return windows, posting deadlines).

In some embodiments, the composite risk score can be mapped to a severity tier using adaptive thresholds conditioned by recent drift metrics, account tenure, and volatility bands. Reliability weights derived from uncertainty measures adjust severity upward or downward to reflect signal quality. Veto and tie-break rules can elevate severity when categorical red flags are present, including missing endorsement, malformed stamp geometry, or out-of-zone placement, regardless of a low numeric aggregate. Policy gates can also escalate severity when any channel-specific indicator exceeds institution-configured ceilings or when jurisdictional or consent constraints restrict corroboration sources.

In some embodiments, an action-selection matrix can be used to associate severity tiers and dominant reason-code families with recommended operational dispositions. Example dispositions can include approve, soft-review queueing, funds-hold placement with configurable duration and release conditions, routing into an exception processing channel for expedited review, inter-entity notification through interface 124, and breach-of-warranty claim initiation. The action-selection matrix may incorporate channel and instrument constraints so that, for example, exception processing routing is applied to check-presentment workflows, while equivalent exception pathways are applied to other document types.

In some embodiments, a cost-sensitive optimizer selects among candidate actions by minimizing expected loss subject to operational and regulatory constraints. The optimizer can compute expected loss as a function of risk probability, exposure at risk, recovery factors, and action costs, and can include penalties for false positives, review capacity limits, and customer experience impacts. Where multiple actions meet policy and cost criteria, a tie-break preference can prioritize faster containment, lower latency, or lower downstream manual effort. Rate limiting and queue prioritization can balance workload across review teams and maintain service-level objectives during peaks.

In some embodiments, configuration artifacts can be used to define action policies, severity mappings, and optimization coefficients on a per-institution or per-portfolio basis. Versioned policy bundles may enable controlled promotion and rollback, and feature flags enable phased adoption of new dispositions.

In some embodiments, outcomes from operational actions feed a continuous-learning loop. Adjudication results, realized loss data, and review feedback recalibrate thresholds, update cost models, and adjust action-selection coefficients. Shadow evaluation and A/B comparisons can validate policy changes against historical or mirrored traffic under statistically controlled criteria before broad deployment.

In some embodiments, the hold funds 502 step can automatically place a hold on funds associated with the suspect transaction. This action prevents immediate withdrawal or further processing of funds, mitigating potential financial losses and enabling sufficient time for investigation and remedial action.

In some embodiments, the exception processing routing 504 step can automatically reroute the suspect item into an exception process and/or clearing for expedited review. This routing mechanism isolates the item from standard processing workflows, enabling detailed manual or automated examination, particularly for items exhibiting anomalies in endorsement imagery, temporal patterns, or cross-channel correlations.

In some embodiments, the breach-of-warranty claim initiation 506 step can automatically initiate a breach-of-warranty claim against the presenting financial institution when a high-confidence discrepancy is identified. This action holds the presenting institution accountable for the fraudulent item in accordance with interbank agreements and regulatory requirements, enabling recovery of funds and compliance with industry standards.

In some embodiments, the actions can include multi-stage responses. For example, a provisional action (for example, a short-duration funds hold or temporary exception processing) can be applied immediately, followed by scheduled follow-up tasks such as targeted re-reads, additional repository queries, or enhanced due diligence checks. Timeouts and expiry policies can release provisional actions automatically when corroboration subsequently reduces assessed risk, while escalation timers can extend holds or trigger claim initiation when corroboration confirms elevated risk before regulatory deadlines.

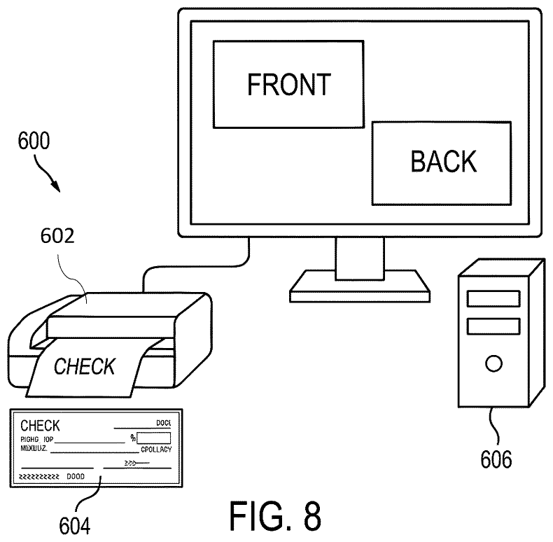

FIG. 8 illustrates a system for check image processing configured for automated fraud detection and validation. FIG. 8 shows a remote deposit scanner 600, a scanner interface 602, a document 604, and a workstation computer 606. The remote deposit scanner 600 operates as an image acquisition device that captures high-resolution images of both the front and back sides of the document 604. In some embodiments, the remote deposit scanner 600 can include one or more devices for remote deposit capture for processing of a document, such as a bank check. Thus, the remote deposit scanner 600 can include a consumer device (e.g., laptop, smartphone, tablet, etc.), automated banking system (e.g., ATM, kiosk, etc.), or bank device/system such as a system for bank teller image capture and/or lockbox image capture, among others or any combination thereof. The scanner interface 602 provides a conduit for transferring captured images to the workstation computer 606, which hosts software components for downstream processing.

In some embodiments, the workstation computer 606 is implemented as a laptop or notebook executing capture and analysis client software; in alternative embodiments, the workstation computer 606 is provided as a thin client or virtual desktop infrastructure terminal with processing offloaded to a data center host. Further alternatives include a tablet device (Windows, Android, or iPadOS) executing a capture application; a smartphone configured as a mobile capture and upload endpoint; an embedded controller integrated into a scanner or a multi-function peripheral; a single-board computer edge node (x86 or ARM, including Raspberry Pi-or Jetson-class platforms); a branch server or on-premises appliance located in a back office; a teller or point-of-sale terminal integrated with banking peripherals; an ATM host module or kiosk controller; a network edge or IoT gateway with Ethernet, Wi-Fi, or 4G/5G backhaul; an on-premises virtual machine or container deployed on hyperconverged infrastructure; a cloud-hosted virtual machine receiving images from the scanner; a containerized microservice (Kubernetes or Docker) providing capture, OCR, and ML; a serverless function or managed OCR/ML service invoked after image upload; and a networked multi-function printer/scanner providing onboard compute and storage for local preprocessing.

In some embodiments, the scanner interface 602 can include any document scanning facility. For example, the scanner interface 602 can include, e.g., document-image acquisition is performed using dedicated document scanners comprising flatbed scanners employing CCD or CIS sensors, sheet-fed or automatic document feeder duplex scanners for bi-sided capture, and production or high-volume scanners configured with continuous feed mechanisms for sustained throughput. Overhead book or document scanners with cradle support can provide gentle handling for bound materials and irregular media while maintaining geometric fidelity for downstream analysis. For example, the scanner interface 602 can include, e.g., multi-function peripherals utilized as networked printer/copier/scanner devices and office copiers configured with scan-to workflows targeting folders, email, or cloud repositories. In some embodiments, financial and check imaging devices are employed, including remote deposit capture scanners, teller-line check scanners, lockbox or remittance processors with integrated imaging, and point-of-sale check readers incorporating imaging modules to acquire front and back artifacts of negotiable instruments. For example, the scanner interface 602 can include, e.g., camera-based capture is enabled through smartphone cameras executing a guided capture application, tablet cameras with real-time edge detection and perspective correction, desktop or overhead document cameras compliant with UVC or USB standards, and standalone digital cameras mounted on tripods or rigs under controlled lighting to improve signal quality. In some embodiments, kiosk and ATM capture modules provide self-service intake through ATM check or image units and document-intake imagers integrated within public or branch kiosks. The scanner interface 602 can be implemented as a camera device for bank teller image capture, lockbox image capture, or other image capture configurations, or any combination thereof and in any combination with the devices of the remote deposit scanner 600.

In some embodiments, the workstation computer 606 executes an image processing workflow comprising several steps. The image acquisition module of the remote deposit scanner 600 captures a front-side image and a back-side image of the document 604. The scanner interface 602 transfers the captured images to the workstation computer 606. The workstation computer 606 executes the OCR module 106 to extract alphanumeric data, including payee name, date, and amount. The ML classifier 108 identifies endorsement imagery, including handwritten signatures, printed or stamped endorsements, and alphanumeric endorsement data. The workstation computer 606 aggregates the extracted front-side and back-side features into a unified analytic data object for further validation.

The unified analytic data object is transmitted to a fraud detection engine 118, which compares the processed data against reference data, performs temporal pattern analysis 128, and executes cross-channel correlation engine 130 to identify discrepancies. The fraud detection engine 118 detects altered endorsement stamps, mismatched payee information, or other anomalies not evident from the front-side image alone. Integration of front and back images into a single analytic pipeline enhances detection of fraudulent activities and enables real-time decision making.

In some embodiments, the remote deposit scanner 600 is deployed in business environments that process checks in bulk via remote deposit capture systems. The system validates checks at the point of capture, reducing the risk of fraud and enabling timely operational responses, such as placing funds holds 220 or initiating breach-of-warranty claims 506.

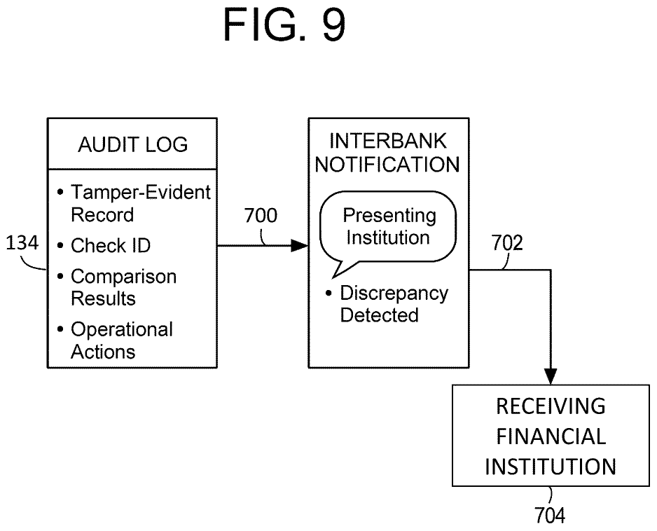

FIG. 9 illustrates an audit log and notification framework 900 configured to generate tamper-evident records and transmit interbank notifications 700 to a receiving financial institution 704 via a secure communication path 702. The audit log and notification framework 900 provides transparency, traceability, and rapid cross-entity communication for fraud-related events within multi-institution environments.

In some embodiments, the audit log 134 records analytical steps, intermediate features, and operational actions associated with fraud detection workflows. Tamper-evident records are produced by cryptographically hashing event payloads and metadata, with hash chains or signed receipts preserving integrity across write operations. Recorded artifacts can include a unique check identifier, issuance-and repository-comparison results, temporal and cross-channel scores, heuristic flags, fusion outcomes, and executed dispositions such as funds holds, non-standard routing, and claim initiation. Provenance fields capture module versions, calibration sets, thresholds, and decision rationales to support time-correct reconstruction, regulatory examination, and interbank dispute resolution.

In some embodiments, interbank notification 700 conveys discrepancy and recommendation data to a designated receiving financial institution 704 under authenticated, encrypted transport secure communication path 702, e.g., encrypted transport. Notification content can include presenting-institution identity, detected discrepancy categories, composite risk and confidence measures, dominant reason codes, and recommended operational steps. Delivery semantics may employ synchronous push or asynchronous queueing with acknowledgment, retry, and deduplication controls. Jurisdiction tags, consent scopes, and purpose codes accompany payloads to enforce governance constraints during downstream handling.

In some embodiments, the audit log 134 and interbank notification 700 operate in concert to document detection outcomes and propagate actionable signals. Logged records provide immutable evidence of analytic lineage and operational decisions, while notifications enable coordinated responses that mitigate loss exposure and preserve regulatory return windows. The framework 900 supports consistent, auditable, and performance-aware communication among participating institutions, strengthening reliability of fraud detection and enhancing security posture across the financial ecosystem.

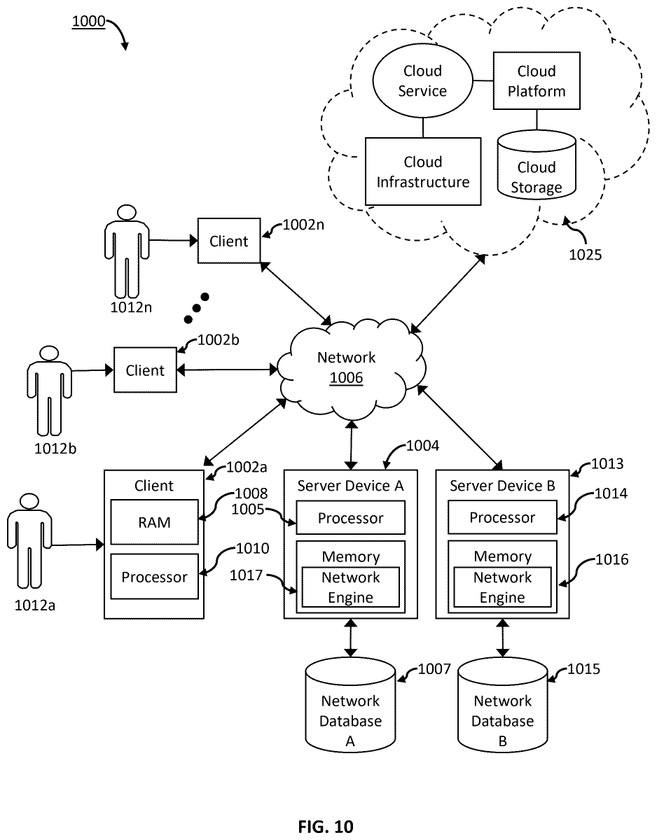

FIG. 10 depicts a block diagram of another exemplary computer-based system and platform 1000 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the client device 1002a, client device 1002b through client device 1002n shown each at least includes a computer-readable medium, such as a random-access memory (RAM) 1008 coupled to a processor 1010 or FLASH memory. In some embodiments, the processor 1010 may execute computer-executable program instructions stored in memory 1008. In some embodiments, the processor 1010 may include a microprocessor, an ASIC, and/or a state machine. In some embodiments, the processor 1010 may include, or may be in communication with, media, for example computer-readable media, which stores instructions that, when executed by the processor 1010, may cause the processor 1010 to perform one or more steps described herein. In some embodiments, examples of computer-readable media may include, but are not limited to, an electronic, optical, magnetic, or other storage or transmission device capable of providing a processor, such as the processor 1010 of client device 1002a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, client devices 1002a through 1002n may also comprise a number of external or internal devices such as a mouse, a CD-ROM, DVD, a physical or virtual keyboard, a display, or other input or output devices. In some embodiments, examples of client devices 1002a through 1002n (e.g., clients) may be any type of processor-based platforms that are connected to a network 1006 such as, without limitation, personal computers, digital assistants, personal digital assistants, smart phones, pagers, digital tablets, laptop computers, Internet appliances, and other processor-based devices. In some embodiments, client devices 1002a through 1002n may be specifically programmed with one or more application programs in accordance with one or more principles/methodologies detailed herein. In some embodiments, client devices 1002a through 1002n may operate on any operating system capable of supporting a browser or browser-enabled application, such as Microsoft™, Windows™, and/or Linux. In some embodiments, client devices 1002a through 1002n shown may include, for example, personal computers executing a browser application program such as Microsoft Corporation's Internet Explorer™, Apple Computer, Inc.'s SafariTM, Mozilla Firefox, and/or Opera. In some embodiments, through the member computing client devices 1002a through 1002n, user 1012a, user 1012b through user 1012n, may communicate over the exemplary network 1006 with each other and/or with other systems and/or devices coupled to the network 1006. As shown in FIG. 10, exemplary server devices 1004 and 1013 may include processor 1005 and processor 1014, respectively, as well as memory 1017 and memory 1016, respectively. In some embodiments, the server devices 1004 and 1013 may be also coupled to the network 1006. In some embodiments, one or more client devices 1002a through 1002n may be mobile clients.

In some embodiments, at least one database of exemplary databases 1007 and 1015 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

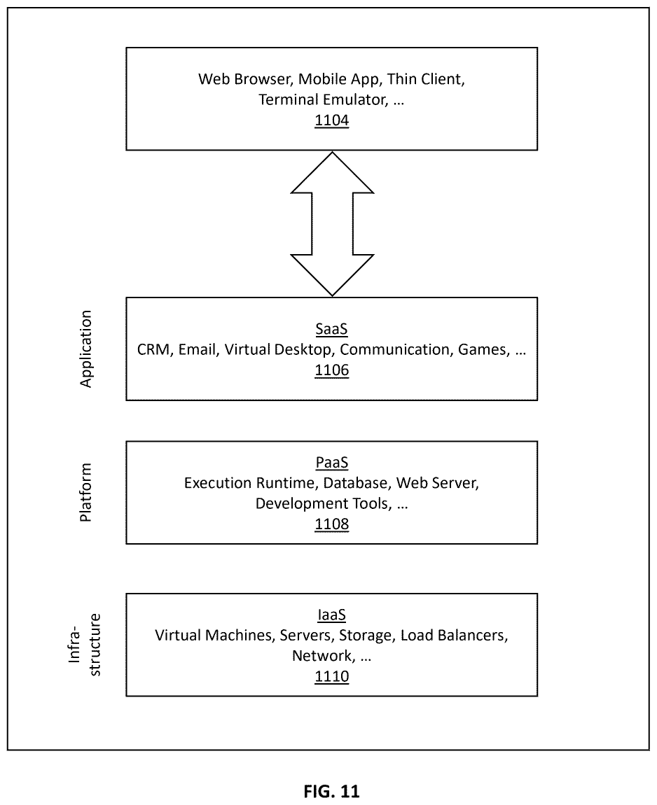

In some embodiments, the exemplary inventive computer-based systems/platforms, the exemplary inventive computer-based devices, and/or the exemplary inventive computer-based components of the present disclosure may be specifically configured to operate in a cloud computing/architecture 1025 such as, but not limiting to: infrastructure a service (IaaS) 1110, platform as a service (PaaS) 1108, and/or software as a service (Saas) 1106 using a web browser, mobile app, thin client, terminal emulator or other endpoint 1104. FIG. 11 illustrates schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

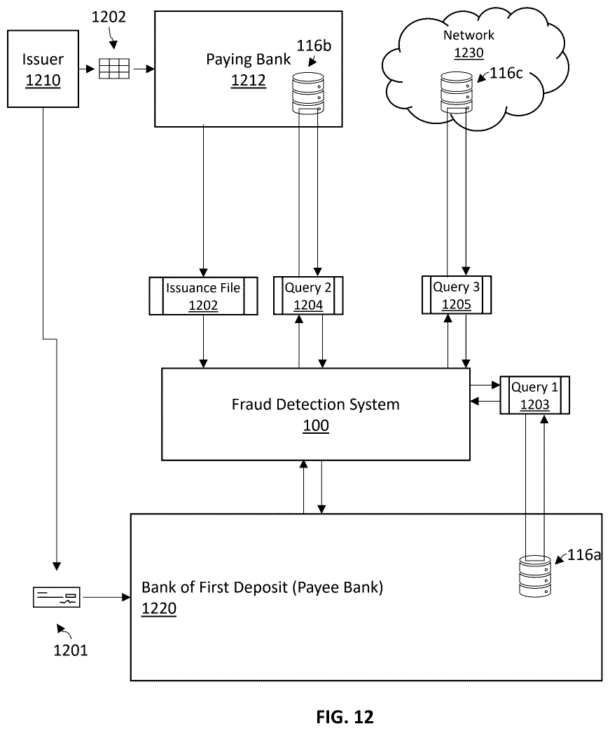

FIG. 12 illustrates a check fraud detection system configured to verify and authenticate presented checks through collaborative data exchange.

In some embodiments, a fraud detection system 100 can include an issuer 1210 of a document item such as a bank check, a paying bank 1212 associated with the document item (e.g., a bank of a payer) and a bank of first deposit 1220 (e.g., the payee bank). The issuer 1210 may issue a check 1201 having a front and back, where the front includes fields such as item number, amount, date and payee name, as well as the payee address information. At the time of issuance, the back of the check may be blank, and may be endorsed by a payee before and/or upon deposit. Bank processing data can be added to the back of the check as the check progresses through bank processing at the BOFD 1220. Thus, the back of the check includes a record of the payee endorsement and processing by the bank, including characteristics such as endorsement imagery, including handwritten endorsements, the bank processing data and endorsement stamps. An API inquiry 1211 originating from the bank of first deposit (BOFD) 1220 can be directed to the paying bank 1212, a consortium of banks, a central orchestrator in a federated system, etc. In some embodiments, the paying bank 1212 may issue an inquiry to the issuer on behalf of the BOFD 1220 and/or consortium. the fraud detection system 100 upon receipt of a presented check or check image, initiating cross-entity validation workflows.

In some embodiments, the fraud detection system 100 aggregates and normalizes three primary input categories. Issuer inputs can include a check issuance file 1202, e.g., including payee, payee address, item number, item date, amount, and account information, among other data or any combination thereof. In some embodiments, the fraud detection system 100 may be a computer system that is a part of or associated with the BOFD 1220, such as a set of computer components hosted locally by the BOFD 1220. In some embodiments, the BOFD 1220 may be a remote set of computer components, such as a cloud-hosted, server hosted, distributed or other computing system that the BOFD 1220 may access via a network connection. In some embodiments, in a remote hosted implementation, the fraud detection system 100 may be connected to one or more banks by the network 1230. For example, the fraud detection system 100 may be a shared resource or otherwise accessible by one or more banks on the network 1230, e.g., via permissioned access by a suitable computer interface such as APIs. In another example, the fraud detection system 100 may be accessible via the network 1230 only by the associated institution such as the BOFD 1220. In some embodiments, the fraud detection system 100 may be implemented according to any other architecture or any combination of architectures suitable to allow the BOFD 1220 to access the fraud detection system 100 to perform fraud detection using the front and back of check imagery, including a locally hosted architecture, remote hosted architecture, cloud hosting, server, distributed computing, federated computing, distributed ledger (e.g., blockchain) based architecture, or other or any combination thereof.

In some embodiments, the network 1230 may include one or more electronic communication architectures to enable interbank communication. For example, the network 1230 may be implemented in a consortium-based approach (e.g., as described above in relation to FIG. 6). Other implementations are also contemplated. For example, the network 1230 may include one or more connections over the Internet or other network (e.g., SWIFT, ACH, or other proprietary or non-proprietary network). In some embodiments, the network 1230 may refer to a set of direct connections that the BOFD 1220 has established with other systems, such as peer-to-peer connections (e.g., direct secure transport overlays such as TLS-mutual authentication over private peering, IPsec site-to-site tunnels, WireGuard point-to-point links, and SSH-tunneled port forwarding, X.25/Frame Relay, MPLS L3VPN with BGP peering, and private L2 extensions (EVPN/VXLAN), among others or any combination thereof). In some embodiments, the network 1230 may refer to a federated network having a central orchestrator that mediates electronic communications across the member banks. Any other networking topology may be employed or any combination thereof.

The BOFD 1220 can provide endorsement images for comparison to incoming checks such as previously paid items or registered endorsement specimens, signature images captured during account opening, historical item image data, and account alerts comprising stop-payment instructions or negative-file indicators. Items such as payee name, payee address, item number, item date, amount, and account information, endorsement images, etc. can be provided to the fraud detection system 100, the network 1230 and/or their respective bank by customers, or may be collected through other means such as historical aggregation of data. Potential partner inputs can include negative files listing known counterfeit checks, off-us images sourced from third-party repositories, and account owner risk data contributed by external risk networks.

In some embodiments, upon an issuer 1210, such as payer customer, generates a check 1201 and sends the check to the payee, the issuer 1210 can produce an issuance file 1202 to the paying bank 1212 (and/or any other entity or institution associated with recording the document item) recording the front-of-check information. In some embodiments, the issuer 1210 can provide the issuance file 1202, e.g., via API or other messaging and/or interface mechanism, to the paying bank 1212. Upon receipt of the check, the payee may prepare the check for deposit by, for example, applying a handwritten endorsement and/or stamp endorsement. Once the endorsement(s) is/are applied, the payee can deposit the check at the BOFD 1220.

In some embodiments, upon receipt of the check 1201, the BOFD 1220 can use the fraud detection system 100 to perform front of check and back of check fraud analysis. For front of check analysis, the BOFD 1220 may, where a communication network between banks is in place, query for the issuance file, such as be an API or other messaging and/or interface mechanism, to the paying bank 1212 or other repository holding the issuance file 1202. In some cases, the repository may be associated with the paying bank 1212, with a consortium, may be part of a federated and/or distributed architecture, among other arrangements or any combination thereof. For example, the fraud detection system 100, as detailed above, can identify the issuance file 1202 from the paying bank 1212 that is associated with the check 1201 to verify the front of check fields against recorded information at the issuer 1210.

In some embodiments, for back of check analysis, the fraud detection system 100 may query the repository 116a of the BOFD 1220 and/or, where the communication network between banks is in place, one or more other repositories 116b and/or 116c. In some embodiments, the repository 116a/116b/116c can store historical transactions with endorsement, address, and/or other data to compare to the back of check data. This historical data can be used to analyze the endorsement and/or bank processing data of the back of check imagery to identify any anomalies that may indicate fraud.

In some embodiments, the issuance file 1202 and the historical transactions can be stored in one or more of the repositories 116a, 116b and/or 116c, including, e.g., in an intra-bank, multi-bank, peer-to-peer, federated, consortium or other architecture. In some embodiments, the issuance file and the historical transactions can be stored in separate repositories For example, in some embodiments, the fraud detection system 100 may emit a first query 1203 to the local repository 116a of the BOFD 1220. The fraud detection system 100 could also, or instead, emit queries 1204 and/or 1205 to other repositories such as the issuer repository 116b and/or the verification repository 116c. Thus, the fraud detection system 100 can query repositories across the repository based on which bank or entity is most likely to include back of check-related data for analyzing the back of check imagery.

In some embodiments, upon emitting the query 1203, 1204 and/or 1205, the fraud detection system 100 performs analysis that cross-references presented check details and endorsement imagery against aggregated inputs to identify discrepancies and corroborating signals. The fraud detection system 100 then returns a response to the requesting entity, the BOFD 1220, with fraud detection results, such as, e.g., a risk score quantifying fraud likelihood, structured response elements identifying matched and mismatched fields, and a recommendation for operational actions comprising approval, funds-hold placement, or further review.

In some embodiments, the fraud detection system 100 may detect discrepancies of the endorsement imagery from historical examples using one or more machine learning, similarity and/or pattern matching techniques based on features identified by the endorsement extraction, including e.g., OCR and/or machine learning classification as detailed above in reference to FIG. 1, among other feature extraction and/or feature engineering techniques or any combination thereof. For example, handwriting analysis and machine learning-based pattern analysis may be used to compare features associated with a handwritten and/or other endorsement (e.g., business endorsement stamp) to features of past examples associated with the payee in the repository 116a/116b/116c. Similarly, bank processing data on the back of the check can be analyzed relative to prior examples in the repository 116a/116b/116c associated with the payee. In some embodiments, the pattern analysis can include, e.g., one or more machine learning techniques, similarity measurement, correlation measurement, among others or any combination thereof.

In some embodiments, the exemplary inventive computer-based systems/platforms, the exemplary inventive computer-based devices, and/or the exemplary inventive computer-based components of the present disclosure may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
a. i) define Neural Network architecture/model,
b. ii) transfer the input data to the exemplary neural network model,
c. iii) train the exemplary model incrementally,
d. iv) determine the accuracy for a specific number of timesteps,
e. v) apply the exemplary trained model to process the newly-received input data,
f. vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

In some embodiments, data entries may be matched according to a measure of similarity of individual or combinations of attributes represented in the data entries. In some embodiments, the measure of similarity may include, e.g., an exact match or a predetermined similarity score according to, e.g., cross-correlation, autocorrelation, Jaccard similarity, Jaro-Winkler similarity, Cosine similarity, Euclidean similarity, Overlap similarity, Pearson similarity, Approximate Nearest Neighbors, K-Nearest Neighbors, among other similarity measure. The predetermined similarity score may be any suitable similarity score according to the type of electronic activity to identify a measured attribute of any two data entries as the same.

The depicted architecture enables real-time or near-real-time fraud detection and operational decisioning by unifying issuer references, interbank endorsement histories, and external risk contributions under a secure, governed exchange. The collaborative framework enhances detection accuracy, reduces false positives through cross-entity corroboration, and mitigates financial losses by coupling analytic outcomes to actionable dispositions within existing banking workflows.

In some embodiments, a business customer can originate the check 1201 and a payee can prepare a deposit at the bank of first deposit 1220 using a restrictive endorsement. In some embodiments, the restrictive endorsement may specify a bank of first deposit identifier, a business name, and an account number, etc. thereby limiting negotiability to a designated institution and account to reduce unauthorized presentment.

In some embodiments, paying entities operate as originators of negotiable instruments and providers of authoritative reference data for downstream verification. Paying entities generate checks or other document items, maintain issuance records comprising payee data, dates, amounts, and identifiers.

In some embodiments, payee entities apply the restrictive endorsements during deposit preparation. The payee entity initiates deposits across supported intake channels and, in certain deployments, supply issuance files, endorsement exemplars, and signature specimens that anchor comparisons within the broader fraud-detection system.

In some embodiments, the restrictive endorsement functions as a back-of-document control limiting negotiability to a designated financial institution and account. Restrictive endorsement can include a bank identifier, a business name, and an account number, optionally with standardized phrases such as “FOR DEPOSIT ONLY.” Restrictive endorsement supplies high-salience features to OCR module 106 and ML classifier 108 pipelines, informs heuristic validator 132 checks for zone placement and density, and furnishes inputs to comparison engine 110 for cross-entity corroboration.

In some embodiments, multiple deposit channels can convey checks and associated images to the depository bank or Bank of First Deposit (BOFD) 1220. For example, a lockbox service can support secure, high-volume intake for accounts receivable environments, remote deposit capture can enable electronic submission of front and back images acquired by enterprise scanners, over-the-counter check deposit can accommodate teller-line intake with immediate capture and validation, mobile deposit can utilize mobile applications to capture and transmit images under device guidance and quality gates, and ATMs can provide self-service image capture and deposit forwarding through banking infrastructure.

In some embodiments, banks of the network 1230 participate in a governed data-sharing framework aggregating endorsement imagery, embeddings, adjudication outcomes, and risk contributions. Consortium banks can access verification repository 116c or directory-mediated peer exchanges to provide cross-entity references for comparison engine 110 and corroboration signals for fraud detection engine 118. Within the broader system, consortium banks expand similarity baselines, reduce institution-specific blind spots, and enable coordinated operational responses. Thus, in some embodiments, consortium data access enhances similarity scoring and anomaly detection across institution boundaries, reducing exploitation of institution-specific gaps and improving disposition accuracy under time-correct comparisons.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) Open VMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™. (18) QNX™; (19) Mono; (20) Google Blink; (21) Apple WebKit; (22) Mozilla Gecko™; (23) Mozilla XUL; (24) . NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999) , at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™ Pager, Smartphone, or any other reasonable mobile electronic device.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), Whirlpool, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A computer-implemented method for detecting fraudulent or altered document items, comprising:
extracting, by at least one processor, using at least one image analysis model, back image feature data comprising at least one back image feature associated with the at least one back image data item represented in a back image of a document item;
wherein the at least one back image data item represents at least one item, on a back of the document item, comprising:
a handwritten signature,
at least one printed endorsement,
at least one stamped endorsement,
at least one alphanumeric endorsement data, or
at least one bank processing data item;
detecting, by the at least one processor, using at least one endorsement-feature pattern analysis, at least one discrepancy of the back image feature data from reference data;
wherein the reference data comprises historical endorsement imagery stored in a verification repository, the verification repository comprising endorsement imagery, transaction history, and risk data contributed and updated in near real-time by a plurality of participating entities;
wherein the at least one endorsement-feature pattern analysis comprises at least one of:
temporal pattern analysis on the endorsement-feature data across a plurality of previously presented document items to identify behavioral anomalies, or
correlation analysis between the endorsement-feature data and transaction data from at least one additional data channel; and
automatically routing, by the at least one processor, based at least in part on the discrepancy, the document item to at least one operational action to mitigate fraud associated with the discrepancy.

2. The computer-implemented method of claim 1, wherein extracting endorsement imagery from the back image of the presented document item further comprises segmenting an endorsement region using image processing algorithms to isolate handwritten signatures, printed or stamped endorsements, and alphanumeric endorsement data.

3. The computer-implemented method of claim 1, wherein analyzing the extracted endorsement imagery using optical character recognition and machine-learning pattern recognition further comprises generating feature vectors representing signature geometry, stamp placement, and text content for subsequent comparison.

4. The computer-implemented method of claim 1, wherein comparing the endorsement-feature data to reference data further comprises executing a similarity scoring algorithm to quantify a degree of match between the extracted endorsement-feature data and historical endorsement imagery stored in the verification repository.

5. The computer-implemented method of claim 1, wherein performing temporal pattern analysis on the endorsement-feature data comprises applying time-series anomaly detection models to identify outlier behaviors in endorsement presentation frequency and sequence.

6. The computer-implemented method of claim 1, wherein performing cross-channel correlation between the endorsement-feature data and transaction data from at least one additional data channel comprises integrating data from automated clearing house transactions, wire transfers, and payment card activity using a multi-modal data fusion engine.

7. The computer-implemented method of claim 1, wherein determining that a discrepancy exists further comprises applying a threshold-based decision logic to a similarity scoring algorithm, temporal pattern analysis, and cross-channel correlation.

8. The computer-implemented method of claim 1, wherein automatically generating a response instruction comprises invoking a rule-based operational response engine configured to select and execute one or more operational actions based on a type and severity of the detected discrepancy.

9. The computer-implemented method of claim 1, further comprising generating a tamper-evident audit log by cryptographically hashing each step of an endorsement validation and response instruction process and storing the hashes in an immutable ledger.

10. The computer-implemented method of claim 1, wherein the verification repository is accessed via secure application programming interfaces, and is associated with at least one of:
a payee entity associated with receiving the document item, or a payer entity associated with issuing the document item.

11. A fraud-detection system for identifying potentially fraudulent business checks, comprising:
one or more processors; and
a memory storing instructions executable by the processors to:
extract, using at least one image analysis model, back image feature data comprising at least one back image feature associated with the at least one back image data item represented in a back image of a document item;
wherein the at least one back image data item represents at least one item, on a back of the document item, comprising:
a handwritten signature,
at least one printed endorsement,
at least one stamped endorsement,
at least one alphanumeric endorsement data, or
at least one bank processing data item;
detect, using at least one endorsement-feature pattern analysis, at least one discrepancy of the back image feature data from reference data;
wherein the reference data comprises historical endorsement imagery stored in a verification repository, the verification repository comprising endorsement imagery, transaction history, and risk data contributed and updated in near real-time by a plurality of participating entities;
wherein the at least one endorsement-feature pattern analysis comprises at least one of:
temporal pattern analysis on the endorsement-feature data across a plurality of previously presented document items to identify behavioral anomalies, or
correlation analysis between the endorsement-feature data and transaction data from at least one additional data channel; and
automatically rout, based at least in part on the discrepancy, the document item to at least one operational action to mitigate fraud associated with the discrepancy.

12. The system of claim 11, wherein extracting endorsement imagery from the back image of the presented document item further comprises segmenting an endorsement region using image processing algorithms to isolate handwritten signatures, printed or stamped endorsements, and alphanumeric endorsement data.

13. The system of claim 11, wherein analyzing the extracted endorsement imagery using optical character recognition and machine-learning pattern recognition further comprises generating feature vectors representing signature geometry, stamp placement, and text content for subsequent comparison.

14. The system of claim 11, wherein comparing the endorsement-feature data to reference data further comprises executing a similarity scoring algorithm to quantify a degree of match between the extracted endorsement-feature data and historical endorsement imagery stored in the verification repository.

15. The system of claim 11, wherein performing temporal pattern analysis on the endorsement-feature data comprises applying time-series anomaly detection models to identify outlier behaviors in endorsement presentation frequency and sequence.

16. The system of claim 11, wherein performing cross-channel correlation between the endorsement-feature data and transaction data from at least one additional data channel comprises integrating data from automated clearing house transactions, wire transfers, and payment card activity using a multi-modal data fusion engine.

17. The system of claim 11, wherein determining that a discrepancy exists further comprises applying a threshold-based decision logic to a similarity scoring algorithm, temporal pattern analysis, and cross-channel correlation.

18. The system of claim 11, wherein automatically generating a response instruction comprises invoking a rule-based operational response engine configured to select and execute one or more operational actions based on a type and severity of the detected discrepancy.

19. The system of claim 11, further comprising generating a tamper-evident audit log by cryptographically hashing each step of an endorsement validation and response instruction process and storing the hashes in an immutable ledger.

20. The system of claim 11, wherein the verification repository is accessed via secure application programming interfaces, and is associated with at least one of:
a payee entity associated with receiving the document item, or
a payer entity associated with issuing the document item.
